(19) United States
(12) Patent Application Publication
(10) Pub. No.: US 2024/0331395 A1
(43) Pub. Date: Oct. 3, 2024

(54) SYSTEMS AND METHODS FOR GENERATING VEHICLE AND/OR INDIVIDUAL NAVIGATION ROUTES FOR THE PURPOSE OF AVOIDING CRIMINAL ACTIVITY

(71) Applicant: William Holloway Petrey, Jr., Frisco, TX (US)

(72) Inventors: William Holloway Petrey, JR., Frisco, TX (US); Steven Mason, Las Vegas, NV (US)

(73) Assignee: William Holloway Petrey, Jr., Frisco, TX (US)

(21) Appl. No.: 18/742,034

(22) Filed: Jun. 13, 2024

Related U.S. Application Data
(63) Continuation-in-part of application No. 18/518,136, filed on Nov. 22, 2023.
Application No. 18/518,136 is a continuation-in-part of application No. 17/688,340, filed on Mar. 7, 2022, now Pat. No. 11,915,485.
Application No. 17/688,340 is a continuation of application No. 16/910,949, filed on Jun. 24, 2020, now Pat. No. 11,270,129.
(60) Provisional application No. 62/866,278, filed on Jun. 25, 2019.
(60) Provisional application No. 63/562,966, filed on Mar. 8, 2024.

(51) Int. Cl. G06V 20/54; G06V 20/62; G06V 40/16; G08B 7/06; G08B 25/10

(52) U.S. Cl. CPC G06V 20/54; G06V 20/63; G06V 40/161; G08B 7/06; G06V 20/625; G08B 25/10

(57) ABSTRACT

Methods for generating routes for the purpose of avoiding locations of risk-heightened events (RHEs). The method includes receiving first data indicating a first location corresponding to an origination location of a user and a vehicle occupied by the user. The method also includes receiving second data indicating a second location corresponding to a destination location and the vehicle. The method further includes receiving third data indicating criteria related to traveling between the first and second locations. The third data indicates a mode of travel between the first and second locations or a desired departure time for traveling between the first and second locations. The method also includes obtaining fourth data indicating the locations of RHEs in a route calculation space containing the first and second locations. The method further includes calculating, based on the first, second, third, and fourth data, a route between the first and second locations.

### CROSS-REFERENCES TO RELATED APPLICATIONS

This application claims priority to and is a continuation-in-part of U.S. patent application Ser. No. 18/518,136 (Attorney Docket No. 85299-116) filed Nov. 22, 2023, entitled “System and Method for Predicting the Presence of an Entity at Certain Locations,” which is a continuation-in-part of U.S. patent application Ser. No. 17/688,340 (Attorney Docket No. 85299-106) filed Mar. 7, 2022, now U.S. Pat. No. 11,915,485, entitled “System and Method for Correlating Electronic Device Identifiers and Vehicle Information,” which is a continuation of U.S. patent application Ser. No. 16/910,949 (Attorney Docket No. 85299-101) filed Jun. 24, 2020, now U.S. Pat. No. 11,270,129, entitled “System and Method for Correlating Electronic Device Identifiers and Vehicle Information,” which claims priority to and the benefit of U.S. Provisional Application Ser. No. 62/866,278 (Attorney Docket No. 85299-100) filed Jun. 25, 2019, the entire disclosures of which are hereby incorporated by reference.

This application also claims priority to and is a conversion of U.S. Provisional Application Ser. No. 63/562,966 (Attorney Docket No. 85299-115) filed Mar. 8, 2024, entitled “System and Methods for Generating Vehicle and/or Individual Navigation Routes for the Purposes of Avoiding Criminal Activity.”

### TECHNICAL FIELD

This disclosure relates generally to generating travel/transportation routes for a vehicle and/or individual.

### BACKGROUND

Many public and private areas, including airports, business parks, companies, border checkpoints, neighborhoods, etc. employ measures to enhance the safety of the people and property on the area premises. For example, some neighborhoods are gated and visitors to the communities may be forced to check-in with a guard at a security gate prior to being allowed into the neighborhood. Some neighborhoods employ a crime watch group that includes a group of concerned citizens who work together with law enforcement to help keep their neighborhood safe. Such a program may rely on volunteers to patrol the neighborhood to help law enforcement discover and/or thwart suspicious and/or criminal activity. However, these and other conventional measures lack the ability to correlate certain information that provides for enhanced identification, tracking, and notification of and/or to suspicious vehicles/individuals.

### SUMMARY

In general, the present disclosure provides systems and methods for suspicious person identify and notification.

This disclosure provides a method for generating one or more routes for the purpose of avoiding locations of risk-heightened events (RHEs). The method includes receiving first data indicating a first location. The first location corresponds to an origination location of at least one of a user and a vehicle occupied by the user. The method also includes receiving second data indicating a second location. The second location corresponds to a destination location of the at least one of the user and the vehicle occupied by the user. The method further includes receiving third data indicating one or more criteria related to traveling between the first location and the second location. The third data indicates at least one of: (i) a mode of travel between the first location and the second location and (ii) a desired departure time for traveling between the first location and the second. The method also includes obtaining fourth data indicating the locations of RHEs in a route calculation space containing the first location and the second location. The method further includes calculating, based on the first data, the second data, the third data, and the fourth data, at least one route between the first location and the second location. The method also includes generating and providing, at an interface of a first device associated with the user, route information that indicates the at least one route.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), solid state drives (SSDs), flash, or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

It should be noted that the term “cellular media access control (MAC) address” may refer to a MAC, international mobile subscriber identity (IMSI), mobile station international subscriber directory number (MSISDN), enhanced network selection (ENS), or any other form of unique identifying number.

### BRIEF DESCRIPTION OF THE DRAWINGS

For a more complete understanding of this disclosure and its advantages, reference is now made to the following description, taken in conjunction with the accompanying drawings, in which:

FIG. 1A illustrates a high-level component diagram of an example of a system architecture, according to certain embodiments of this disclosure;

FIG. 1B illustrates an example of trilateration using the system architecture of FIG. 1A, according to certain embodiments of this disclosure;

FIG. 2 illustrates details pertaining to various components of the system architecture of FIG. 1A, according to certain embodiments of this disclosure;

FIG. 3 illustrates an example of a method for monitoring vehicle traffic, according to certain embodiments of this disclosure;

FIG. 4 illustrates another example of a method for monitoring vehicle traffic, according to certain embodiments of this disclosure;

FIG. 5 illustrates examples of user interfaces presented on computing devices during monitoring vehicle traffic, according to certain embodiments of this disclosure;

FIG. 6 illustrates an example computer system according to certain embodiments of this disclosure;

FIG. 7 illustrates a block diagram of a system for predicting a location of an entity;

FIG. 8 illustrates example location data;

FIG. 9 illustrates a diagram depicting the prediction of a next location of an entity from a current location;

FIG. 10 illustrates a diagram for determining locations to avoid;

FIG. 11 is a flow diagram depicting an embodiment of a method for predicting a location of an entity;

FIG. 12 is a flow diagram depicting an embodiment of a method for predicting a next location for an entity from a current location of the entity;

FIG. 13 is a flow diagram depicting an embodiment of a method for determining locations to avoid;

FIGS. 14A, 14B, and 14C illustrate examples of route generation to avoid locations; and

FIG. 15 is a flow diagram depicting a method for generating a route to avoid locations.

### DETAILED DESCRIPTION

Improvement is desired in the field of public safety for certain areas (e.g., neighborhood, airport, business park, border checkpoint, city, etc.). As discussed above, there are various measures that may be conventionally used, such as gated communities, neighborhood crime watch groups, and so forth. However, the conventional measures lack efficiency and accuracy in identifying suspicious vehicles/individuals and reporting of the suspicious vehicles/individuals, among other things. In some instances, the conventional measures may fail to report the suspicious vehicle/individual, altogether. The causes of the inefficient and/or failed reporting may be at least in part attributable to people (e.g., neighbors in a neighborhood) not having access to verified vehicle and/or personal information of an individual. Further, the conventional measures lack the ability to quickly, accurately, and automatically identify the vehicle as a suspicious vehicle, correlate vehicle information (e.g., license plate identifier (ID)), electronic device information (e.g., electronic device identifier (ID)), face information, etc., and/or perform a preventative action based on the identification.

Take the following example for illustrative purposes. A neighbor may witness an unknown vehicle drive through the neighborhood several times within a given time period during a day. The neighbor may not recognize the license plate ID or driver and may think about reporting the unknown vehicle to law enforcement. Instead, the neighbor may decide to proceed to do another activity. Subsequently, the person may burglarize a house in the neighborhood. Even if the neighbor attempted to lookup the license plate ID, and was able to find out information about an owner of the vehicle, the neighbor may not be able to determine whether the driver of the vehicle is the actual owner, the neighbor may not be able to determine whether the owner or driver is on a crime watch list, and so forth. Further, the neighbor may not be privy to the electronic device identifier of the electronic device the suspicious individual is carrying or that is installed in the vehicle, which may be used to track the whereabouts of the individual/vehicle in a monitored area. Even if a neighbor obtains an electronic device identifier, there currently is no technique for determining personal information associated with the electronic device identifier. To reiterate, conventional techniques for public safety lack the ability to identify a suspicious vehicle/individual and/or to correlate vehicle information, facial information, and/or electronic device identifiers of electronic devices of the driver to make an informed decision quickly, accurately, and automatically.

Aspects of the present disclosure relate to embodiments that overcome the shortcomings described above. The present disclosure relates to a system and method for correlating electronic device identifiers with vehicle information. The system may include one or more license plate detection zones, one or more electronic device detection zones, and/or one or more facial detection zones. The zones may be partially or wholly overlapping and there may be multiple zones established that span a desired area (e.g., a neighborhood, a city block, a public/private parking lot, any street, etc.). The license plate detection zones, the electronic device detection zones, and/or the facial detection zones may include devices that are communicatively coupled to one or more computing systems via a network. The license plate detection zones may include one or more cameras configured to capture images of at least license plates on vehicles that enter the license plate detection zone. The electronic device detection zone may include one or more electronic device identification sensors, such as a Wi-Fi signal detection device or a Bluetooth® signal detection device. The electronic device identification sensors may be configured to detect and store Wi-Fi Machine Access Control (MAC) addresses, Bluetooth MAC addresses, and/or cellular MAC addresses (e.g., International Mobile Subscriber Identity (IMSI), Mobile Station International Subscriber Directory Number (MSISDN), and Electronic Serial Numbers (ESN)) of electronic devices that enter the electronic device detection zone based on the signals emitted by the electronic devices. The facial detection zones may include one or more cameras configured to capture images or digital frames that are used to recognize a face. Any suitable MAC address may be detected, and to that end, a MAC address may be any combination of the IDs described herein (e.g., MAC, MSISIDN, IMSI, ESN, etc.).

The computing system may analyze the images captured by the cameras and detect a license plate identifier (ID) of a vehicle. The license plate ID may be compared with trusted license plate IDs that are stored in a database. When there is not a trusted license plate ID that matches the license plate ID, the computing system may identify the vehicle as a suspicious vehicle. Then, the computing system may correlate the license plate ID of the vehicle with at least one of the stored electronic device identifiers. In some embodiments, the license plate ID and the at least one of the stored electronic device identifiers may be correlated with a face of the individual. In some embodiments, personal information, such as name, address, Bluetooth MAC address, Wi-Fi MAC address, criminal record, whether the suspicious individual is on a crime watch list, etc. may be retrieved using the license plate ID or the at least one of the stored electronic device identifiers that is correlated with the license plate ID of the suspicious vehicle.

The system may include several computer applications that may be accessed by registered users of the system. For example, a client application may be accessed by a computing device of a user, such as a neighbor in a neighborhood implementing the system. The client application may present a user interface including an alert when a suspicious vehicle and/or individual is detected. The user interface may present several preventative actions for the user. For example, the user may contact the suspicious individual using the personal information (e.g., send a threatening text message), notify law enforcement, and so forth. Accordingly, a client application may be accessed by a computing device of a law enforcer. The client application may present a user interface including the notification that a suspicious vehicle and/or individual is detected in the particular zones.

Take the following example of a setup of the system for illustration purposes. In a neighborhood, that may only be accessed by two entrances, license plate detection zones and electronic device detection zones may be placed to cover both lanes at both entrances. In some instances, a facial detection zone may be placed at the entrances with the other zones. Each vehicle may be correlated with each electronic device that enters the neighborhood. Further, the recognized face may be correlated with the electronic device and the vehicle information. The houses inside the neighborhood may setup electronic device detection zones and/or a facial detection zone inside their property to detect electronic device IDs and/or faces and compare them with electronic device IDs and/or faces in a database that stores every correlation that has been made by the system to date (including the most recent correlations of electronic device IDs, faces, and/or vehicles entering the neighborhood). The home owner may be notified via the client application on their computing device if an electronic device and/or face is detected on their property. Further, in some embodiments, the individual associated with the electronic device and/or face may be notified on the electronic device that the homeowner is aware of their presence. If a known criminal with a warrant is detected at either the zones at the entrance or at the zones at the homeowner's property, the appropriate law enforcement agency may be notified of their whereabouts.

The disclosed techniques provide numerous benefits over conventional systems. For example, the system provides efficient, accurate, and automatic identification of suspicious vehicles and/or individuals. Further, the system enables correlating vehicle license plate IDs with electronic device identifiers to enable enhanced detection and/or preventative actions, such as directly communicating with the electronic device of the suspicious individual and/or notifying law enforcement using the client application in real-time or near real-time when the suspicious vehicle enters one or more zones. For example, once the electronic device identifier is detected, a correlation may be obtained with a license plate ID to obtain personal information about the owner that enables contacting the owner directly and/or determining whether the owner is a criminal. The client application provides pertinent information pertaining to both the suspicious vehicle and/or individual in a single user interface without the user having to perform any searches of the license plate ID or electronic device identifier. As such, in some embodiments, the disclosed techniques reduce processing, memory, and/or network resources by reducing searches that the user may perform to find the information. Also, the disclosed techniques provide an enhanced user interface that presents the suspicious vehicle and/or individual information in single location, which may improve a user's experience using the computing device.

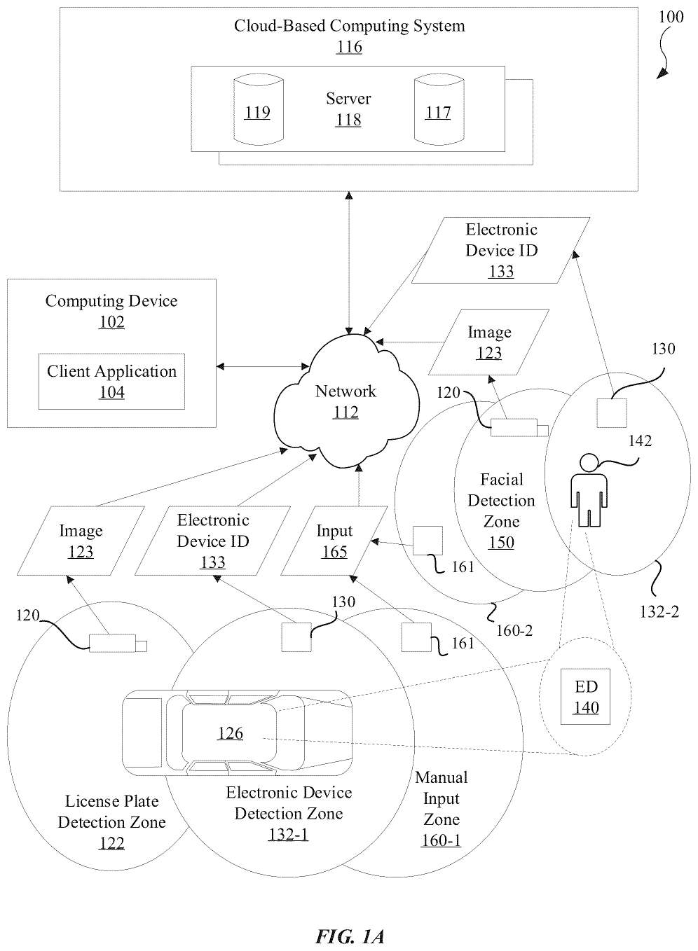

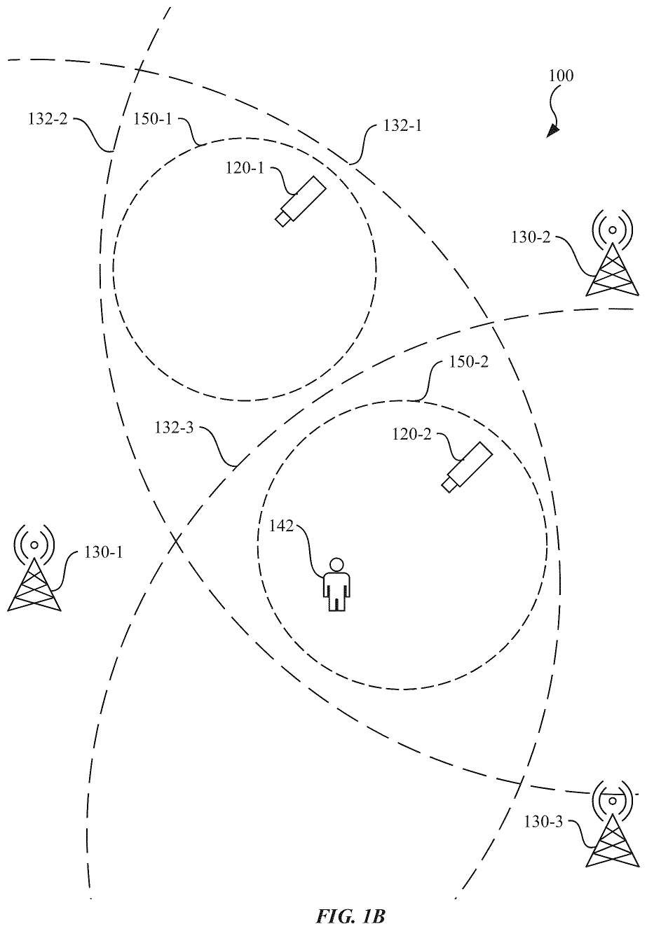

FIG. 1A illustrates a high-level component diagram of a system architecture 100 according to certain embodiments of the present disclosure. In some embodiments, the system architecture 100 may include a computing device 102 communicatively coupled to a cloud-based computing system 116, one or more cameras 120, one or more electronic device identification sensors 130, and/or one or more electronic devices 140 of a suspicious individual. The cloud-based computing system 116 may include one or more servers 118. Each of the computing device 102, the servers 118, the cameras 120, the electronic device identification sensors 130, and the electronic device 140 may include one or more processing devices, memory devices, and network interface devices.

The network interface devices may enable communication via a wireless protocol for transmitting data over short distances, such as Bluetooth, ZigBee, etc. Additionally, the network interface devices may enable communicating data over long distances, and in one example, the computing device 102 may communicate with a network 112. Network 112 may be a public network (e.g., connected to the Internet via wired (Ethernet) or wireless (Wi-Fi)), a private network (e.g., a local area network (LAN) or wide area network (WAN)), or a combination thereof.

The computing device 102 may be any suitable computing device, such as a laptop, tablet, smartphone, or computer. The computing device may be configured to execute a client application 104 that presents a user interface. The client application 104 may be implemented in computer instructions stored on one or more memory devices and executed by one or more processing devices of the computing device 102. The client application 104 may be a standalone application installed on the computing device 102 or may be an application that is executed by another application (e.g., a website in a web browser).

The computing device 102 may include a display that is capable of presenting the user interface of the client application 104. The user interface may present various screens to a user depending on what type of user is logged into the client application 104. For example, a user, such as a neighbor or person interested in one of the license plate detection zones 122 and/or electronic device detection zone 132, may be presented with a user interface for logging into the system where the user enters credentials (username and password), a user interface that displays alerts of suspicious vehicles and/or individuals in the zones 122 and/or 132 where the user interface includes options for preventative actions, a user interface that presents logged events over time, and so forth. For example, the client application 104 may enable the user to directly contact (e.g., send text message, send email, call) the electronic device 140 of a suspicious individual 142 using personal information obtained about the individual 142. Another user, such as a law enforcer, may be presented with a user interface for logging into the system where the user enters credentials (username and password), a user interface that displays notifications when the user selects to notify law enforcement where the notifications may include information related to the suspicious vehicle and/or individual 142.

In some embodiments, the cameras 120 may be located in the license plate detection zones 122. Although just one camera 120 and one license plate detection zone 122 are depicted, it should be noted that any suitable number of cameras 120 may be located in any suitable number of license plate detection zones 122. For example, multiple license plate detection zones 122 may be used to cover a desired area. A license plate detection zone 122 may refer to an area of coverage that is within the cameras' 120 field of view. The cameras 120 may be any suitable camera and/or video camera capable of capturing a set of images 123 that at least represent license plates of a vehicle 126 that enters the license plate detection zone 122. The set of images 123 may be transmitted by the camera 120 to the cloud-based computing system 116 and/or the computing device 102 via the network 112.

In some embodiments, the electronic device identification sensors 130 may be located in the electronic device detection zones 132. In some embodiments, the license plate detection zone 122 and the electronic device detection zone 132-1 may partially or wholly overlap. The combination of license plate detection zones 122 and the electronic device detection zones 132 may be setup at entrances/exits to certain areas, and/or any other suitable area in a monitored area, to correlate each vehicle information with respective electronic device identifiers 133 of electronic devices 140 being carried in respective vehicles 126. Each of the license plate detection zones 122 and electronic device detection zones 132 may have unique geographic identifiers so the data can be tracked by location. It should be noted that any suitable number of electronic device identification sensors 130 may be located in any suitable number of electronic device detection zones 132. For example, multiple electronic device detection zones 132 may be used to cover a desired area. An electronic device detection zone 132 may refer to an area of coverage that is within the electronic device identification sensor 130 detection area.

In one example, an electronic device detection zone 132-2 and/or a facial detection zone 150 may be setup at a home of a homeowner, such that an electronic device 140 and/or a face of a suspicious individual 142 may be detected and stored when the suspicious individual 142 enters the zone 132-2. The electronic device ID 133 and/or an image of the face may be transmitted to the cloud-based computing system 116 or the computing device 102 via the network 112. In some instances, the suspicious individual 142 may be contacted on their electronic device 140 with a message indicating the homeowner is aware of their presence and to leave the premises. In some instances, if a known criminal individual 142 with a warrant is detected at the combination of zones 122 and 132-1 at an entrance or at the zone 132-2 and 150 at the home, then the proper law enforcement agency may be contacted with the whereabouts of the individual 142.

In some embodiments, the cameras 120 may be located in the facial detection zones 150. Although just one camera 120 and one facial detection zone 150 are depicted, it should be noted that any suitable number of cameras 120 may be located in any suitable number of facial detection zones 150. For example, multiple facial detection zones 150 may be used to cover a desired area. A facial detection zone 150 may refer to an area of coverage that is within the cameras' 120 field of view. The cameras 120 may be any suitable camera and/or video camera capable of capturing a set of images 123 that at least represent faces of an individual 142 that enters the facial detection zone 150. The set of images 123 may be transmitted by the camera 120 to the cloud-based computing system 116 and/or the computing device 102 via the network 112. In some embodiments, the cloud-based computing system 116 and/or the computing device 102 may perform facial recognition by comparing a face detected in the image to a database of faces to find a match and/or perform biometric artificial intelligence that may uniquely identify an individual 142 by analyzing patterns based on the individual's facial textures and shape.

The electronic device identification sensors 130 may be configured to detect a set of electronic device IDs 133 (e.g., Wi-Fi MAC addresses, Bluetooth MAC addresses, and/or cellular MAC addresses) of electronic device 140 within the electronic device detection zone 132. As depicted, the electronic device 140 of a suspicious individual is within the vehicle 126 passing through the electronic device detection zone 132. That is, the electronic device identification sensors 130 may be any suitable Wi-Fi signal detection device capable of detecting Wi-Fi MAC addresses and/or Bluetooth signal detection device capable of detecting Bluetooth MAC addresses of electronic devices 140 that enter the electronic device detection zone 132. The set of images 123 may be transmitted by the camera 120 to the cloud-based computing system 116 and/or the computing device 102 via the network 112. The electronic device identification sensor 130 may store the set of electronic device IDs 133 locally in a memory. The electronic device identification sensor 130 may also transmit the set of electronic device IDs 133 to the cloud-based computing system 116 and/or the computing device 102 via the network 112 for storage.

As noted above, the cloud-based computing system 116 may include the one or more servers 118 that form a distributed computing architecture. Each of the servers 118 may be any suitable computing system and may include one or more processing devices, memory devices, data storage, and/or network interface devices. The servers 118 may be in communication with one another via any suitable communication protocol. The servers 118 may each include the database 117 of trusted vehicle license plate IDs, the personal identification database 119, or both. In some implementations, the database 117 of trusted vehicle license plate IDs and the personal identification database 119 may be stored on the computing device 102.

The database 117 of trusted vehicle license plate IDs may be populated by a processing device adding license plate IDs of vehicles that commonly enter the license plate detection zone 122. In some implementations, the database 117 of trusted vehicle license plate IDs may be populated at least in part by manual entry of license plate IDs associated with vehicles trusted to be within the license plate detection zone 122. For example, the license plate IDs may be added at a manual input zone 160-1 using a computing device 161. These license plate IDs may be associated with vehicles owned by neighbors in a neighborhood, or family members of the neighbors, friends of the neighbors, visitors of the neighbors, contractors hired by the neighbors, any suitable person that is trusted, etc.

The personal identification database 119 may be populated by a processing device adding personal identification information associated with electronic device IDs 133 of electronic devices carried by people that commonly enter the electronic device detection zone 132 (e.g., a list of trusted electronic device IDs). In some implementations, the personal identification database 119 may be populated at least in part by manual entry of personal identification information associated with electronic device IDs 133 associated with electronic devices 140 trusted to be within the electronic device detection zone 132 (e.g., a list of trusted electronic device IDs). For example, the personal identification information associated with electronic device IDs 133 may be added at the manual input zone 160-1 using the computing device 161. These electronic device IDs 133 may be associated with electronic devices 140 owned by neighbors in a neighborhood, or family members of the neighbors, friends of the neighbors, visitors of the neighbors, contractors hired by the neighbors, etc. Further, in some implementations, the personal identification database 119 may be populated by entering a list of known suspect individuals from the police department, people entering or exiting border checkpoints, etc.

The personal identification information for untrusted electronic device IDs may also be entered into the personal identification database 119. The personal identification database 119 may also be populated by a processing device adding personal identification information associated with electronic device IDs 133 of electronic devices carried by people that commonly enter the facial detection zone 132 (e.g., face images of trusted individuals). The face images 123 may be manually entered at manual input zone 160-2 using the computing device 161. The personal identification information may include names, addresses, faces, email addresses, phone numbers, electronic device identifiers associated with electronic devices owned by the people (e.g., Bluetooth MAC addresses, Wi-Fi MAC addresses), correlated license plate IDs with the electronic device identifiers, etc. The correlations between the license plate IDs, the electronic device identifiers, and/or the faces may be performed by a processing device using the data obtained from the cameras 120 and the electronic device identification sensors 130. Some of this information may be obtained from public sources, phone books, the Internet, and/or companies that distribute electronic devices. In some implementations, the personal identification information added to the personal identification database 119 may be associated with people selected based on their residing in or near a certain radius of a geographic region where the zones 122 and/or 132 are set up, based on whether they are on a crime watch list, or the like.

In some implementations, the system 100 uses overlapping detection zones of multiple electronic device identification sensors to narrow the location area of an individual. For example, in FIG. 1B, the three detection zones 132-1, 132-2, and 132-3 of the three electronic device identification sensors 130-1, 130-2, and 130-3 partially overlap with each other. Further, the individual 142 in FIG. 1B is positioned within the overlapping portions of the three detection zones 132-1, 132-2, and 132-3. Thus, when all three electronic device identification sensors 130-1, 130-2, and 130-3 detect an electronic device carried by the individual 142, the system 100 may determine that the individual 142 is located within the overlapping portions of the three detection zones 132-1, 132-2, and 132-3.

In some implementations, the system 100 may further narrow the location area of the individual 142 using trilateration (or multilateration). Each of the three electronic device identification sensors 130-1, 130-2, and 130-3 may determine, based on the signal strength of the electronic device carried by the individual 142, the distance to the individual 142. For example, electronic device identification sensor 130-2 may determine that the electronic device carried by the individual 142 is close to electronic device identification sensor 130-2 when the signal strength is strong or determine that the electronic device is far from electronic device identification sensor 130-2 when the signal strength is weak. Alternatively, or in addition, each of the three electronic device identification sensors 130-1, 130-2, and 130-3 may determine the distance to the individual 142 by measuring the time delay that a signal takes to return to the electronic device identification sensors 130-1, 130-2, and 130-3 from the electronic device carried by the individual 142. For example, electronic device identification sensor 130-3 may determine that the electronic device carried by the individual 142 is close to electronic device identification sensor 130-3 when the time delay is short or determine that the electronic device is far from electronic device identification sensor 130-3 when the time delay is long. “Short” and “long,” as used in the foregoing may refer to any amount of time delay without restriction, so long that the constraint, in any given instance, is that a long time delay be for a greater period of time than a short time delay.

$$x = \frac{\begin{matrix}( {r}_{1}^{2} - {r}_{2}^{2} - {x}_{1}^{2} + {x}_{2}^{2} - {y}_{1}^{2} + {y}_{2}^{2} ) ( 2 {y}_{3} - 2 {y}_{3} ) - \\ ( {r}_{2}^{2} - {r}_{3}^{2} - {x}_{2}^{2} + {x}_{3}^{2} - {y}_{2}^{2} + {y}_{3}^{2} ) ( 2 {y}_{2} - 2 {y}_{1} )\end{matrix}}{( 2 {y}_{3} - 2 {y}_{3} ) ( 2 {x}_{2} - 2 {x}_{1} ) - ( 2 {y}_{2} - 2 {y}_{1} ) ( 2 {x}_{3} - 2 {x}_{2} )}$$

$$y = \frac{\begin{matrix}( {r}_{1}^{2} - {r}_{2}^{2} - {x}_{1}^{2} + {x}_{2}^{2} - {y}_{1}^{2} + {y}_{2}^{2} ) ( 2 {x}_{3} - 2 {x}_{2} ) - \\ ( 2 {x}_{2} - 2 {x}_{1} ) ( {r}_{2}^{2} - {r}_{3}^{2} - {x}_{2}^{2} + {x}_{3}^{2} - {y}_{2}^{2} + {y}_{3}^{2} )\end{matrix}}{( 2 {y}_{2} - 2 {y}_{1} ) ( 2 {x}_{3} - 2 {x}_{2} ) - ( 2 {x}_{2} - 2 {x}_{1} ) ( 2 {y}_{3} - 2 {y}_{3} )}$$

The system 100 may, based on the locations of each of the three electronic device identification sensors 130-1, 130-2, and 130-3 and the distances from the electronic device to each of the three electronic device identification sensors 130-1, 130-2, and 130-3, determine the coordinates of the electronic device. For example, the system 100 may determine the coordinates of the electronic device using the follow equations:
wherein:
   x, y=coordinates of the electronic device carried by the individual 142;
   x₁, y₁=coordinates of electronic device identification sensor 130-1;
   r₁=distance between electronic device identification sensor 130-1 and the electronic device;
   x₂, y₂=coordinates of electronic device identification sensor 130-2;
   r₂=distance between electronic device identification sensor 130-2 and the electronic device;
   x₃, y₃=coordinates of electronic device identification sensor 130-3; and
   r₃=distance between electronic device identification sensor 130-3 and the electronic device.

Alternatively, or in addition, the system 100 may further narrow the location area of the individual 142 by selecting a different type of detection device located within the overlapping portions of the three detection zones 132-1, 132-2, and 132-3. For example, there are two cameras 120-1 and 120-2 in FIG. 1B with different facial detection zones 150-1 and 150-2. When all three electronic device identification sensors 130-1, 130-2, and 130-3 detect an electronic device carried by the individual 142, the system 100 may select camera 120-2 with facial detection zone 150-2 that is located within the overlapping portions of the three detection zones 132-1, 132-2, and 132-3. The selected camera 120-2 may then detect the location of the individual 142 within facial detection zone 150-2.

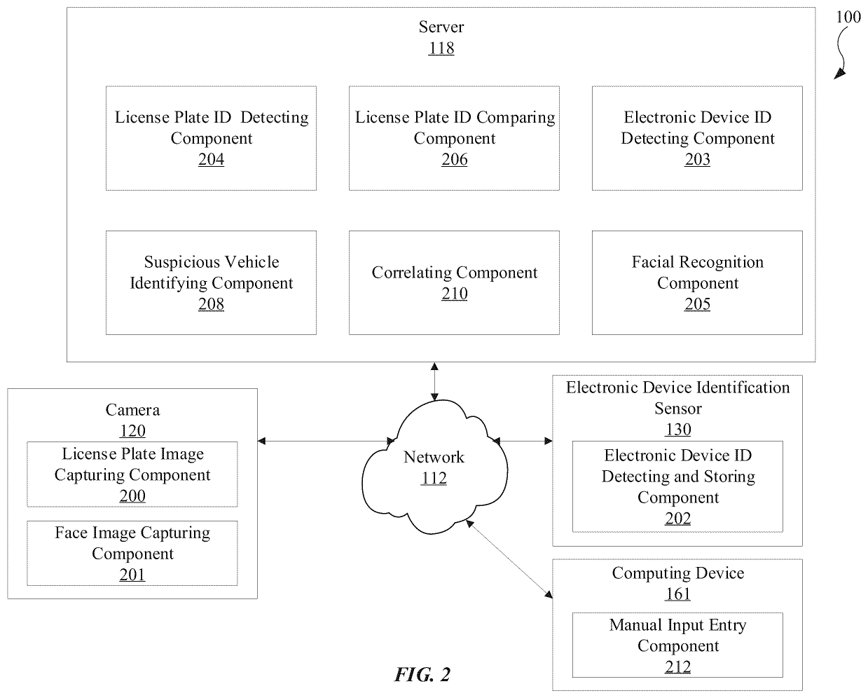

FIG. 2 illustrates details pertaining to various components of the system architecture 100 of FIG. 1A, according to certain implementations of the present disclosure. For example, the camera 120 includes an image capturing component 200 and a face image capturing component 201; the electronic device identification sensor 130 includes an electronic device ID detecting and storing component 202; the server 118 includes an electronic device ID detecting component 203, a license plate ID detecting component 204, a facial recognition component 205, a license plate ID comparing component 206, a suspicious vehicle identifying component 208, and a correlating component 210. In some embodiments, the computing device 161 includes a manual input entry component 212. In some embodiments, the components 203, 204, 205, 206, 208, and 210 may be included in the computing device 102 executing the client application 104. Each of the components 200, 201, 202, 203, 204, 205, 206, 208, 210, and 212 may be implemented in computer instructions stored on one or more memory devices of their respective device and executed by one or more processors of their respective device.

With regards to the image capturing component 200, the component 200 may be configured to capture a set of images 123 within a license plate detection zone 122. At least some of the captured images 123 may represent license plates of a set of vehicles 126 appearing within the field of view of the cameras 120. The image capturing component 200 may configure one or more camera properties (e.g., zoom, focus, etc.) to obtain a clear image of the license plates. The image capturing component 200 may implement various techniques to extract the license plate ID from the images 123, or the image capturing component 200 may transmit the set of images 123, without analyzing the images 123, to the server 118 via the network 112.

With regards to the electronic device ID detecting and storing component 202, the component 202 may be configured to detect and store a set of electronic device IDs 133 of electronic devices located within one or more electronic device detection zones 132. The electronic device ID detecting and storing component 202 may detect a Wi-Fi signal, cellular signal, and/or a Bluetooth signal from the electronic device and be capable of obtaining the Wi-Fi MAC address, cellular MAC address, and/or Bluetooth MAC address of the electronic device from the signal. The electronic device IDs 133 may be stored locally in memory on the electronic device identification sensor 130, and/or transmitted to the server 118 and/or the computing device 102 via the network 112.

With regards to the license plate ID detecting component 204, the component 204 may be configured to detect, using the set of images 123, a license plate ID of a vehicle 126. The license plate ID detecting component 204 may perform optical character recognition (OCR), or any suitable identifier/text extraction technique, on the set of images 123 to detect the license plate IDs.

With regards to the license plate ID comparing component 206, the component 206 may be configured to compare the license plate ID of the vehicle to a database 117 of trusted vehicle license plate IDs. The license plate ID comparing component 206 may compare the license plate ID with each trusted license plate ID in the database 117 of trusted vehicle license plate IDs.

With regards to the suspicious vehicle identifying component 208, the component 208 may identify the vehicle 126 as a suspicious vehicle 126, the identification based at least in part on the comparison of the license plate ID of the vehicle 126 to the database 117 of trusted vehicle license plate IDs. If there is not a trusted license plate ID that matches the license plate ID of the vehicle 126, then the suspicious vehicle identifying component 208 may identify the vehicle as a suspicious vehicle.

With regards to the correlating component 210, the component 210 may be configured to correlate the license plate ID of the vehicle 126 with at least one of the set of stored electronic device IDs 133. Correlating the license plate ID of the vehicle 126 with at least one of the set of stored electronic device IDs 133 may include comparing one or more time stamps of the set of captured images 123 with one or more time stamps of the set of stored electronic device IDs 133. Also, correlating the license plate ID of the vehicle 126 with at least one of the set of stored electronic device IDs 133 may include analyzing at least one of: (i) at least one strength of signal associated with at least one of the set of stored electronic device IDs 133, and (ii) at least one visually estimated distance of at least one vehicle 126 associated with at least one of the set of stored images 123.

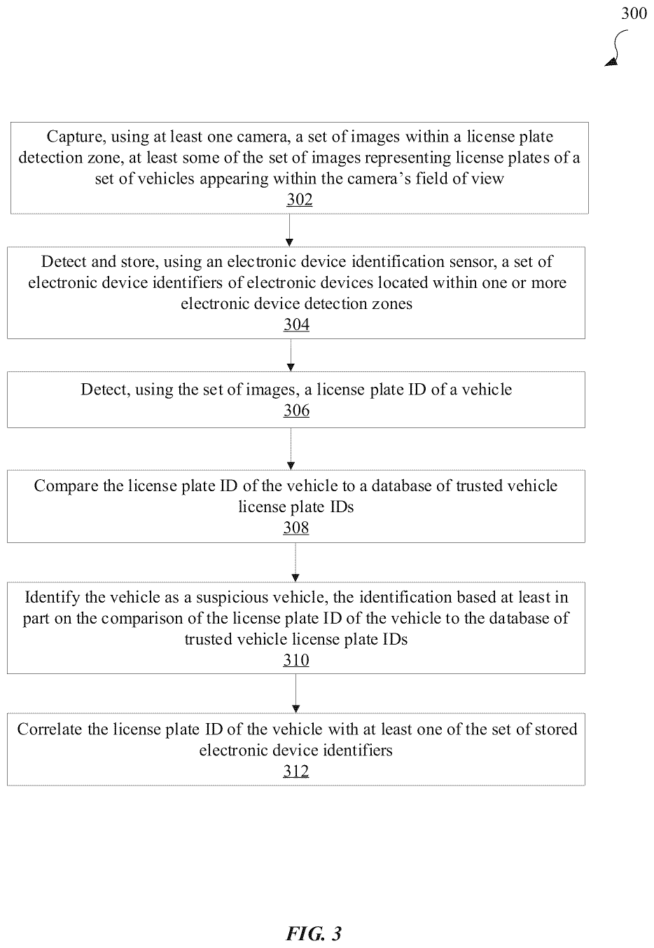

FIG. 3 illustrates an example of a method 300 for monitoring vehicle traffic, according to certain embodiments of this disclosure. The method 300 may be performed by processing logic that may include hardware (circuitry, dedicated logic, etc.), firmware, software, or a combination of both. The method 300 and/or each of their individual functions, subroutines, or operations may be performed by one or more processors of one or more of the devices in FIG. 1A (e.g., computing device 102, cloud-based computing system 116 including servers 118, cameras 120, electronic device identification sensors 130) implementing the method 300. For example, a computing system may refer to the computing device 102 or the cloud-based computing system 116. The method 300 may be implemented as computer instructions that, when executed by a processing device, execute the operations. In certain implementations, the method 300 may be performed by a single processing thread. Alternatively, the method 300 may be performed by two or more processing threads, each thread implementing one or more individual functions, routines, subroutines, or operations of the method 300.

At block 302, a set of images 123 may be captured, using at least one camera 120, within a license plate detection zone 122. At least some of the set of images 123 may represent license plates of a set of vehicles 126 appearing within the camera's field of view. One or more camera properties (e.g., zoomed in, focused, etc.) may be configured to enable the at least one instance of the camera 120 to obtain clear images 123 of the license plates.

At block 304, a set of electronic device identifiers 133 of electronic devices 140 located within one or more electronic device detection zones 132 may be detected and stored using an electronic device identification sensor 130. In some embodiments, the electronic device identification sensor 130 may include at least one of a Wi-Fi signal detection device, cellular signal detection device, or a Bluetooth signal detection device. In some embodiments, the set of electronic device identifiers 133 may include at least one of a Bluetooth MAC address, cellular MAC address, or a Wi-Fi MAC address. In some implementations, at least one of the set of stored electronic device identifiers 133 may be compared with a list of trusted device identifiers.

At block 306, a license plate ID of a vehicle 126 may be detected using the set of images 123. The images 123 may be filtered, rendered, and/or processed in any suitable manner such that the license plate IDs may be clearly detected using the set of images 123. In some embodiments, object character recognition (OCR) may be used to detect the license plate IDs in the set of images 123. The OCR may electronically convert each image in the set of images 123 of the license plate IDs into computer-encoded license plate IDs that may be stored and/or used for comparison.

In some embodiments, a face of the individual 142 may be detected by a camera 120 in the facial detection zone 150. An image 123 may be captured by the camera 120 and facial recognition may be performed on the image to detect the face of the individual. The detected face and/or the image 123 may be transmitted to the cloud-based computing system 116 and/or the computing device 102.

At block 308, the license plate ID of the vehicle 126 may be compared to a database of trusted vehicle license plate IDs. In some implementations, the database 117 of trusted vehicle license plate IDs may be populated at least in part by adding license plate IDs of vehicles 126 that commonly enter the license plate detection zone 122 to the database 117 of trusted vehicle license plate IDs. In some implementations, the database 117 of trusted vehicle license plate IDs may be populated at least in part by manual entry of license plate IDs associated with vehicles 126 trusted to be within the license plate detection zone 122. For example, the trusted vehicles may belong to the neighbors, family members of the neighbors, friends of the neighbors, law enforcement, and so forth.

At block 310, the vehicle may be identified as a suspicious vehicle 126. The identification may be based at least in part on the comparison of the license plate ID of the vehicle to the database 117 of trusted vehicle license plate IDs. For example, if the license plate ID is not matched with a trusted license plate ID stored in the database 117 of trusted vehicle license plate IDs, then the vehicle associated with the license plate ID may be identified as a suspicious vehicle 126.

At block 312, the license plate ID of the vehicle 126 may be correlated with at least one of the set of stored electronic device identifiers 133. In some embodiments, the face of the individual 142 may also be correlated with the license plate ID and the at least one of the set of stored electronic device identifiers 133. In some embodiments, the personal identification database 119 may be accessed. In some embodiments, correlating the license plate ID of the vehicle 126 with at least one of the set of stored electronic device identifiers 133 may include comparing one or more time stamps of the set of captured images 123 with one or more time stamps of the set of stored electronic device identifiers 133. In some embodiments, correlating the license plate ID of the vehicle 126 with the at least one of the set of stored electronic device identifiers 133 may include analyzing at least one of (i) at least one strength of signal associated with at least one of the set of stored electronic device identifiers 133, and (ii) at least one visually estimated distance of at least one vehicle associated with at least one of the set of stored images 123.

Personal identification information of at least one suspicious individual may be retrieved from the personal identification database 119 by correlating information of the personal identification database 119 with the license plate ID of the vehicle 126 or at least one of the set of electronic device identifiers 133 correlated with the license plate ID of the vehicle 126. The personal identification information may also be obtained using a face detected by the camera 120 to obtain the electronic device ID 133 and/or the license plate ID correlated with the face. The personal identification information may include one or more of a name, a phone number, an email address, a residential address, a Bluetooth MAC address, a cellular MAC address, a Wi-Fi MAC address, whether the suspicious individual is on a crime watch list, a criminal record of the suspicious individual, and so forth.

In some embodiments, a user interface may be displayed on one or more computing devices 102 of one or more neighbors when the one or more computing devices are executing the client application 104, and the user interface may present a notification or alert. In some embodiments, the computing device 102 may present a push notification on the display screen and the user may provide user input (e.g., swipe the push notification) to expand the notification on the user interface to a larger portion of the display screen. The alert or notification may indicate that there is a suspicious vehicle 126 identified within the license plate detection zone 122 and/or the electronic device detection zone 132-1 and may provide information pertaining to the vehicle 126 (e.g., make, model, color, license plate ID, etc.) and personal identification information of the suspicious individual (e.g., name, phone number, email address, Bluetooth MAC address, cellular MAC address, Wi-Fi MAC address, whether the individual is on a crime watch list, whether the individual has a criminal record, etc.).

Further, the user interface may present one or more options to perform preventative actions. The preventative actions may include contacting an electronic device 140 of the suspicious individual using the personal identification information. For example, a user may use a computing device 102 to transmit a communication (e.g., at least one text message, phone call, email, or some combination thereof) to the suspicious individual using the retried personal information.

In addition, the preventative actions may also include notifying law enforcement of the suspicious vehicle and/or individual. This preventative action may be available if it is determined that the suspicious individual is on a crime watch list. A suspicious vehicle profile may be created. The suspicious vehicle profile may include the license plate ID of the suspicious vehicle and/or the at least one correlated electronic device identifiers (e.g., Bluetooth MAC address, Wi-Fi MAC address). The user may select the notify law enforcement option on the user interface and the computing device 102 of the user may transmit the suspicious vehicle profile to another computing device 102 of a law enforcement entity that may be logged into the client application 104 using a law enforcement account.

In some embodiments, the preventative action may include activating an alarm upon detection of the suspicious vehicle 126. The alarm may be located in the neighborhood, for example, on a light pole, a tree, a pole, a sign, a mailbox, a fence, or the like. The alarm may be included in the computing device 102 of a user (e.g., a neighbor) using the client application. The alarm may include auditory (e.g., a message about the suspect, a sound, etc.), visual (e.g., flash certain colors of lights), and/or haptic (e.g., vibrations) elements. In some embodiments, the severity of the alarm may change the pattern of auditory, visual, and/or haptic elements based on what kind of crimes the suspicious individual has committed, whether the suspicious vehicle 126 is stolen, whether the suspicious vehicle 126 matches a description of a vehicle involved in an Amber alert, and so forth.

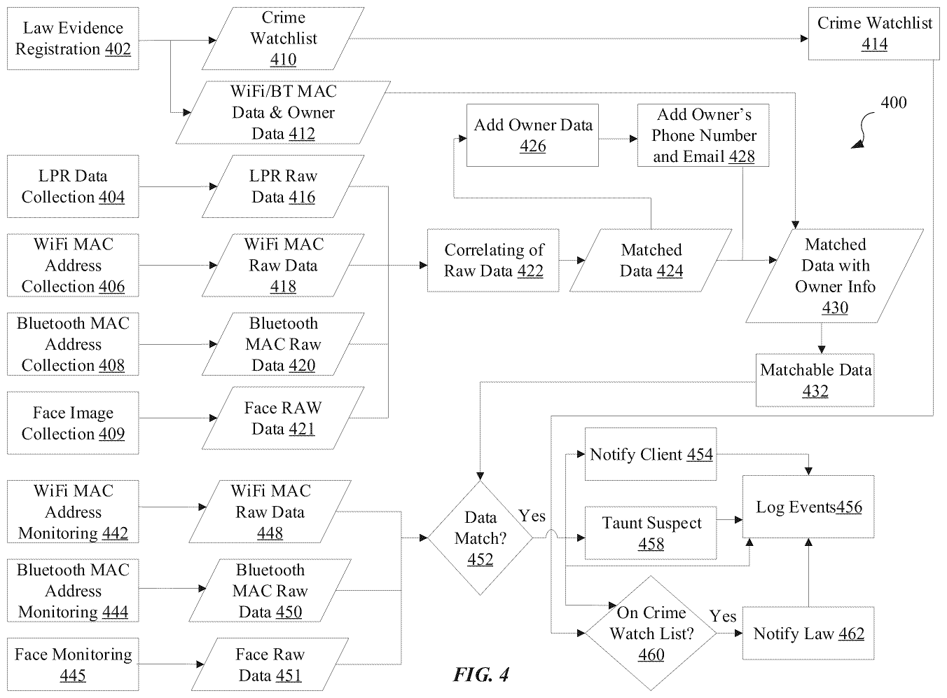

FIG. 4 illustrates another example of a method 400 for monitoring vehicle traffic, according to certain embodiments of this disclosure. Method 400 includes operations performed by one or more processing devices of one or more devices in FIG. 1A (e.g., computing device 102, cloud-based computing system 116 including servers 118, cameras 120, electronic device identification sensors 130) implementing the method 400. In some embodiments, one or more operations of the method 400 are implemented in computer instructions that, when executed by a processing device, execute the operations of the steps. The method 400 may be performed in the same or a similar manner as described above in regards to method 300.

The method 400 may begin with a setup phase where various blocks 402, 404, 406, 408, and/or 409 are performed to register data that may be used to determine whether a vehicle and/or individual is suspicious. For example, at block 402, law evidence may be registered. The law evidence may be obtained from a system of a law enforcement agency. For example, an application programming interface (API) of the law enforcement system may be exposed and API operations may be executed to obtain the law evidence. The law evidence may indicate whether a person is on a crime watch list 410, whether the person has a warrant, whether person has a criminal record, and/or the Wi-Fi/Bluetooth MAC data (address)/cellular data of electronic devices involved in incidents, as well as the owner data 412 of the electronic devices. The crime watch list 410 information may be used to store crime watch list 414 in a database (e.g., personal identification database 119).

At block 404, license plate registration (LPR) data may be collected using the one or more cameras 120 in the license plate detection zones 122 as LPR raw data 416. The LPR raw data 416 may be used to obtain vehicle owner information (e.g., name, address, phone number, email address) and vehicle information (e.g., license plate ID, make, model, color, year, etc.). For example, the LPR raw data 416 may include at least the license plate ID, which may be used to search the Department of Motor Vehicles (DMV) to obtain the vehicle owner information and/or vehicle information. In some instances, the LPR raw data 416 may be collected from manual entry. At block 406, Wi-Fi MAC addresses may be collected from various sources as Wi-Fi MAC raw data 418. For example, the Wi-Fi MAC raw data 418 may be collected from the electronic device identification sensors 130 in the electronic device detection zones 132. In some instances, trusted Wi-Fi MAC addresses may be manually obtained from certain people owning electronic devices in an area covered by the electronic device detection zones 132 and stored in a database (e.g., personal identification database 119). In some embodiments, cellular raw data (e.g., cellular MAC addresses) may be collected from electronic device identification sensors 130. At block 408, Bluetooth MAC addresses may be collected from various sources as Bluetooth MAC raw data 420. For example, the Bluetooth MAC raw data 420 may be collected from the electronic device identification sensors 130 in the electronic device detection zones 132. In some instances, trusted Bluetooth MAC addresses may be manually obtained from certain people owning electronic devices in an area covered by the electronic device detection zones 132 and stored in a database (e.g., personal identification database 119). In some embodiments, the Bluetooth MAC addresses may be collected from the electronic device identification sensors 130 at the electronic device detection zones 132. At block 409, face images may be collected as face raw data 421 by the one or more cameras 120 in the facial detection zones 150. Facial recognition may be performed to detect and recognize faces in the face images.

At block 422, the LPR raw data 416, the Wi-Fi MAC raw data 418, the Bluetooth MAC raw data 420, the cellular raw data, and/or the face raw data 421 may be correlated or paired to generate matched data 424. That is, the data from license plate ID detection, LPR systems, personal electronic device detection, and/or facial information may be combined to generate matched data 424 and stored in the database 117 of trusted vehicle license plate IDs and/or the personal identification database 119. In some embodiments, the license plate IDs are compared to the personal identification database 119 of trusted vehicle license plate IDs to determine whether the detected license plate ID is in the database 117 of trusted vehicle license plate IDs. If not, the vehicle 126 may be identified as a suspicious vehicle and the license plate ID of the vehicle may be correlated with at least one of the set of stored electronic device IDs 133. This may result in creation of a database of detected electronic device identifiers 133 correlated with license plate IDs and facial information of individuals. Any unpaired data may be discarded after unsuccessful pairing.

At block 426, owner data of the electronic devices and/or vehicle may be added to the matched data 424. The owner data may include an owner ID, and/or name, address, and the like. Further, at block 428, owner's phone number and email may be added to the matched data. In addition, Wi-Fi/Bluetooth MAC/cellular data and owner data 412 from the law evidence may be included with the matched data 424 and the personal information of the owner to generate matched data with owner information 430. Accordingly, the owner ID may be associated with combined personal information (e.g., name, address, phone number, email, etc.), vehicle information (e.g., license plate ID, make, model, color, year, vehicle owner information, etc.), and electronic device IDs 133 (e.g., Wi-Fi MAC address, Bluetooth MAC adder). At block 432, the matched data with owner information 430 may be further processed (e.g., formatted, edited, etc.) to generate matchable data. This may conclude the setup phase.

Next, the method 400 may include a monitoring phase. During this phase, the method 400 may include blocks 442, 444, and 445. At block 442, Wi-Fi MAC address monitoring may include one or more electronic device identification sensors 130 detecting and storing a set of Wi-Fi MAC addresses as Wi-Fi MAC raw data 448. In some embodiments, cellular signal monitoring may include one or more electronic device identification sensors 130 detecting and storing a set of cellular MAC addresses as cellular raw data. At block 444, Bluetooth MAC address monitoring may include one or more electronic device identification sensors 130 detecting and storing a set of Bluetooth MAC addresses as Bluetooth MAC raw data 450. At block 445, face monitoring may include the one or more cameras 120 capturing face images and recognizing faces in the face images as face raw data 451. The Wi-Fi MAC raw data 448, Bluetooth MAC raw data 450, and/or face raw data 451 may be compared to matchable data at block 452.

At block 452, the electronic device IDs 133 and/or faces detected by the electronic device identification sensors 130 and/or the cameras 120 may be compared to the matchable data. The matchable data may include personal identification information that is retrieved from at least the personal identification database 119. That is, the detected electronic device IDs 133 and/or faces may be compared to the database 117 of trusted vehicle license plate IDs and/or the personal identification database 119 to find any correlation of the detected electronic device IDs 133 and/or faces with license plate IDs.

If there is a matching electronic device ID to the detected electronic device ID and/or a matching face to the detected face, and there is a correlation with a license plate ID in the database 117 of trusted vehicle license plate IDs and/or the personal identification database 119, then a suspicious vehicle 126/individual 143 may be detected. At block 456, the detected match event may be logged. At block 454, the user interface of the client application 104 executing on the computing device 102 may present an alert of the suspicious vehicle 126/individual 142. At block 456, the detected notification event may be logged. At block 458, the electronic device 140 of the suspicious individual 142 may be notified that his presence is known (e.g., taunted). At block 456, the taunting event may be logged.

At decision block 460, the crime watch list 414 may be used to determine if the identified individual 142 is on the crime watch list 414 using the individual's personal information. If the individual 142 is on the watch list 414, then at block 462, the appropriate law enforcement agency may be notified. At block 456, the law enforcement agency notification event may be logged.

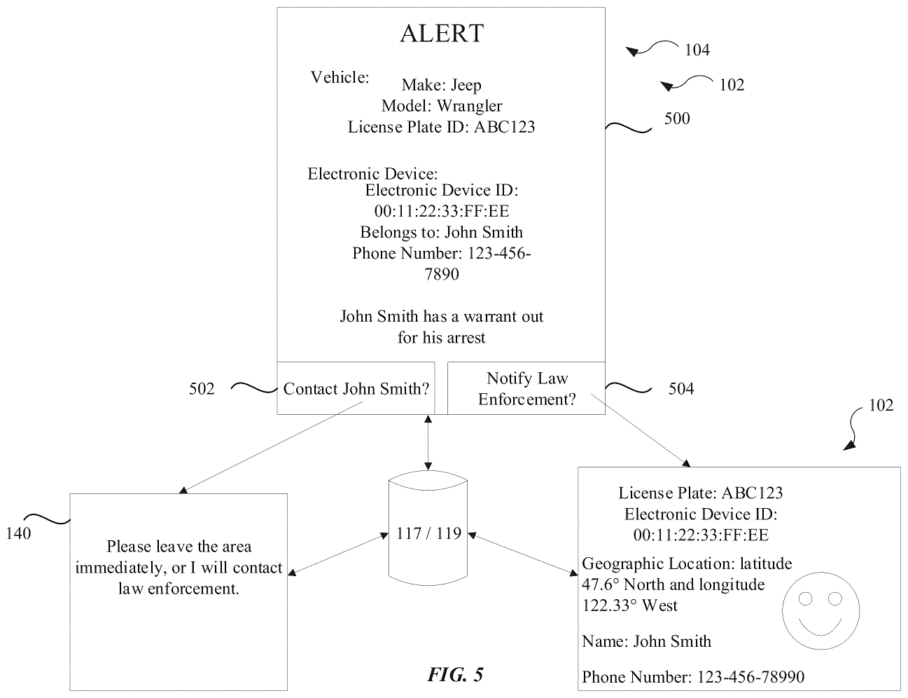

FIG. 5 illustrates example use interfaces presented on computing devices during monitoring vehicle traffic, according to certain embodiments of this disclosure. It should be noted that a user interface 500 may present vehicle information and electronic device information in a single user interface. When a suspicious vehicle 126/individual 142 is detected based on the vehicle license plate ID and/or the electronic device IDs 133, a notification may be presented on the user interface 500 of the client application 104 executing on the computing device 102 of a user (e.g., homeowner, neighbor, interested citizen). As depicted, the notification includes an alert displaying vehicle information and electronic device information. The vehicle information includes the “Make: Jeep”, “Model: Wrangler”, “License Plate ID: ABC123.” The electronic device information includes “Electronic Device ID: 00:11:22:33:FF:EE”, “Belongs to: John Smith”, “Phone Number: 123-456-7890.” Further, the user interface 500 presents that the owner has a warrant out for his arrest. The notification event may be logged in the database 117/119 or any suitable database of the system architecture 100.

The user interface 500 includes various preventative action options represented by user interface element 502 and 504. For example, user interface element 502 may be associated with contacting the detected suspicious individual 142 directly. Upon selection of the user interface element 502, the user may be able to send a text message to the electronic device 140 of the suspicious individual 142. For example, the text message may read “Please leave the area immediately, or I will contact law enforcement.” However, any suitable message may be sent. The message/taunting event may be logged in the database 117/119 or any suitable database of the system architecture 100.

Since the suspicious individual 142 has a warrant out for his arrest and/or is on a crime watch list, the user interface element 504 may be displayed that provides the option to notify law enforcement. Upon selection of the user interface element 504, a notification may be transmitted to a computing device 102 of a law enforcement agency. The notification may include vehicle information (e.g., “License Plate ID: ABC123”), electronic device information (e.g., “Electronic Device ID: 00:11:22:33:FF:EE”), as well as location of the detection (e.g., “Geographic Location: latitude 47.6° North and longitude 122.33° West”), and personal information (“Name: John Smith”, “Phone Number: 123-456-7890”, a face of the individual 142). The law enforcement agency event may be logged in the database 117/119 or any suitable database of the system architecture 100.

Below are example data tables that may be used to implement the system and method for monitoring vehicle traffic disclosed herein. The data tables may include: Client and ID Tables (logID, loginAttempts, clientUser, lawUser, billing), Data Site Info (monitoredSites, dataSites, dataGroups), Raw Collection Data (rawWiFiDataFound, rawBTDataFound, rawLPRDataFound, pairedData), Monitor Data Raw & Matched (monWiFiDataDetected, monBTDataDetected, mon WiFiDataMatched, monBTDataMatched), Subject Data (subjectMatch, subjectInfo, subjectLastSeen, criminalWatchList), Notification Logs (subNotifyLog, subNotifyReplyLog, clientNotifyLog).

TABLE 1
loginID
Table 1: logID is used for login ID/passwords,
authentication and password resets
loginID

username
clientID
idType
rights
email
password
lastLogin

TABLE 2
loginAttempts
Table 2: loginAttempts logs the number of times
logins were attempted for both successes and failures
loginAttempts

clientID
username
timeStamp
IP
wifiRSSI
wifiVendor
wifiLocDet
scanInt

TABLE 3
clientUser
Table 3: clientUser includes information for each user.
clientUser

clientID
username
firstName
lastName
phone1
phone2
phone3
email1
email2
email3
txt1
txt2
txt3
lastUserName
dataIDs
lawID
monID

TABLE 4
lawUser
Table 4: lawUser includes information for law enforcement persononel
wanting to be notified of suspicious vehicles 126/individuals 142.
lawUser

lawUserName
lawID
lawType
lawPrecinct
lawDept
firstName
lastName
phone1
phone2
phone3
email1
email2
email3
txt1
txt2
Txt3
alertType

TABLE 5
billing
Table 5: billing may be used for third-party billing.
billing

clientID
username
package
numMons
options
cardType
cardName
cardAddr1
cardAddr2
cardCity
cardState
cardZIP
cardNum
cardExp
cardID

TABLE 6
monitoredSites
Table 6: monitoredSites includes information for Wi-Fi/
Bluetooth monitoring for detection, among other things.
monitoredSites

monID
monGroupID
clientID
monAddr1
monAddr2
monCity
monState
monZIP
monCountry

TABLE 7
dataSites
Table 7: dataSites includes information for Wi-Fi/
Bluetooth/License Plate Registration detection sites. These
sites may supply data to databases, among other things.
dataSites

dataID
dataAddr1
dataAddr2
dataCity
dataState
dataZIP
dataCountry
groupNum
hwModel
hwSerialNum
softVersion
installDate
devLoc
notes

TABLE 8
dataGroups
Table 8: dataGroups may group data groups and monitored sites.
Groupings such as Homeowner Associations, neighborhoods, etc.
dataGroups

groupID
groupName
groupLocation
groupAddr1
groupAddr2
groupCity
groupState
groupZIP
groupCountry
info

TABLE 9
rawWiFiDataFound
Table 9: rawWiFiDataFound includes raw data dump for
WiFi from detection sites used to look for matches.
rawWiFiDataFound

timeStamp
wifiSync
wifiMAC
wifiDevice
wifiRSSI
wifiVendor
wifiLocDet
scanInt

TABLE 10
rawBTDataFound
Table 10: rawBTDataFound includes raw data dump for
Bluetooth from detection sites used to look for matches.
rawBTDataFound

timeStamp
btSync
btMAC
btName
btRSSI
btVendor
btCOD
btLocDet
scanInt

rawLPRDataFound
Table 11: rawLPRDataFound may include raw LPR data
from detection sites used to look for matches.
rawLPRDataFound

| | |
|---|---|
| timeStamp | lprPic3 |
| lprPlate | lprPic4 |
| lprState | lprPic5 |
| lpreMake | lprPic6 |
| lprModel | lprPic7 |
| lprPlatePic | lprPic8 |
| lprPic1 | lprLocDet |
| lprPic2 | scanInt |

TABLE 12
pairedData
Table 12: pairedData includes matched data that may
be the correlation between vehicle information (e.g.,
license plate IDs) and electronic device IDs 133.
pairedData

| | |
|---|---|
| pairedID | btCOD |
| timeStamp | wifiLocDet |
| lprTimeStamp | btLocDet |
| wifiTimeStamp | lprLocDet |
| btTimeStamp | lprPlatePic |
| lprPlate | lprPic1 |
| lprState | lprPic2 |
| lprMake | lprPic3 |
| lprModel | lprPic4 |
| wifiMAC | lprPic5 |
| wifiDevice | lprPic6 |
| wifiVendor | lprPic7 |
| btMAC | lprPic8 |
| btName | subjectID |
| btVendor | |

TABLE 13
monWiFiDataDetected
Table 13: monWiFiDataDetected logs of any MAC
address data detefcted before matching for WiFi.
monWiFiDataDetected

timestamp
wifiSync
wifiMAC
wifiDevice
wifiRSSI
wifiVendor
wifiMonLoc

TABLE 14
monBTDataDetected
Table 14: monBTDataDetected logs of any MAC
address data detected before matching for Bluetooth.
monBTDataDetected

timestamp
btSync
btMAC
btName
btRSSI
btVendor
btCOD

TABLE 15
monWiFiDataMatched
Table 15: monWiFiDataMatched logs of any matches
moniroted sites find on the database for WiFi.
monWiFiDataMatched

pairedID
timestamp
wifiSync
wifiMAC
wifiDevice
wifiRSSI
wifiVendor
wifiMonLoc

TABLE 16
monBTDataMatched
Table 16: monBTDataMatched logs of any matches
monitored sites find on the database for Bluetooth.
monBTDataMatched

pairedID
timestamp
btSync
btMAC
btName
btRSSI
btVendor
btCOD
btMonLoc

TABLE 17
subjectMatch
Table 17: subjectMatch includes a number of times
subject detected in monitored sites and data sites.
subjectMatch

subjectID
subjectWiFiMAC
subjectBtMAC
timeStamp

TABLE 18
subjectInfo
Table 18: subjectInfo includes information
obtained for owner of license vehicle.
subjectInfo

| | |
|---|---|
| subjectID | subPhone1 |
| subFirstName | subPhone2 |
| subLastName | subPhone3 |
| subDOB | subPhone4 |
| subAddr1 | subPhone5 |
| subAddr2 | subPhone6 |
| subCity | subTxt1 |
| subState | subTxt2 |
| subZIP | subTxt3 |

TABLE 19
subjectLastSeen
Table 19: subjectLastSeen includes locations
where subject was seen with a timestamp.
subjectLastSeen

pairedID
timestamp
subjectID
locID
monID

TABLE 20
criminalWatchList
Table 20: criminalWatchList includes a criminal watch list
that is compared to subjects/individuals 142 to determine
if they are a criminal and who to notify if found.
criminalWatchList

subjectID
crimeType
dateCommitted
notifyIfDetected
status

TABLE 21
subNotifyLog
Table 21: subNotifyLog includes notifications
sent to the subject to discourage crime.
subNotifyLog

timestamp
clientID
subjectID
subPhoneTexted
msgSent
msgStatus

TABLE 22
subNotifyReplyLog
Table 22: subNotifyReplyLog includes any
replies from the subject after notification.
subNotifyReplyLog

timestamp
clientID
subjectID
subPhoneTexted
msgReceived

TABLE 23
clientNotifyLog
Table 23: clientNotifyLog includes log of notification
attempts to the client (e.g., computing device 102 of a user).
clientNotifyLog

timestamp
clientID
msgSent
msgStatus
msgType
numSent
emailSent

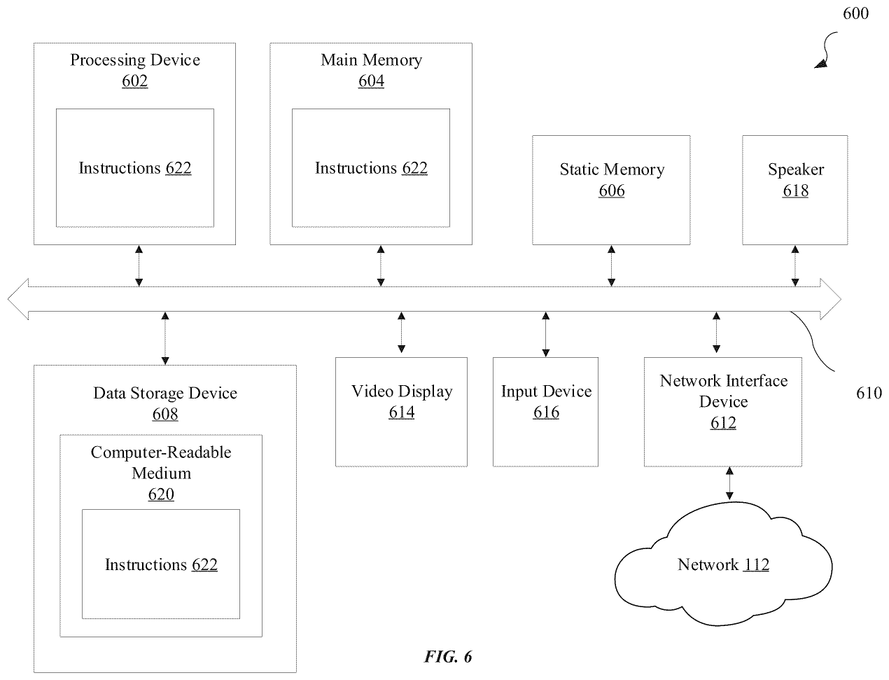

FIG. 6 illustrates example computer system 600 which can perform any one or more of the methods described herein, in accordance with one or more aspects of the present disclosure. In one example, computer system 600 may correspond to the computing device 102, server 118 of the cloud-based computing system 116, the cameras 120, and/or the electronic device identification sensors 130 of FIG. 1A. The computer system 600 may be capable of executing client application 104 of FIG. 1A. The computer system may be connected (e.g., networked) to other computer systems in a LAN, an intranet, an extranet, or the Internet. The computer system may operate in the capacity of a server in a client-server network environment. The computer system may be a personal computer (PC), a tablet computer, a wearable (e.g., wristband), a set-top box (STB), a personal Digital Assistant (PDA), a mobile phone, a camera, a video camera, an electronic device identification sensor, or any device capable of executing a set of instructions (sequential or otherwise) that specify actions to be taken by that device. Further, while only a single computer system is illustrated, the term “computer” shall also be taken to include any collection of computers that individually or jointly execute a set (or multiple sets) of instructions to perform any one or more of the methods discussed herein.

The computer system 600 includes a processing device 602, a main memory 604 (e.g., read-only memory (ROM), flash memory, dynamic random access memory (DRAM) such as synchronous DRAM (SDRAM)), a static memory 606 (e.g., solid state drive (SSD), flash memory, static random access memory (SRAM)), and a data storage device 608, which communicate with each other via a bus 610.

Processing device 602 represents one or more general-purpose processing devices such as a microprocessor, central processing unit, or the like. More particularly, the processing device 602 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 602 may also be one or more special-purpose processing devices such as an application specific integrated circuit (ASIC), a field programmable gate array (FPGA), a digital signal processor (DSP), network processor, or the like. The processing device 602 is configured to execute instructions for performing any of the operations and steps discussed herein.

The computer system 600 may further include a network interface device 612. The computer system 600 also may include a video display 614 (e.g., a liquid crystal display (LCD) or a cathode ray tube (CRT)), one or more input devices 616 (e.g., a keyboard and/or a mouse), and one or more speakers 618 (e.g., a speaker). In one illustrative example, the video display 614 and the input device(s) 616 may be combined into a single component or device (e.g., an LCD touch screen).

The data storage device 616 may include a computer-readable medium 620 on which the instructions 622 (e.g., implementing control system, user portal, clinical portal, and/or any functions performed by any device and/or component depicted in the FIGURES and described herein) embodying any one or more of the methodologies or functions described herein is stored. The instructions 622 may also reside, completely or at least partially, within the main memory 604 and/or within the processing device 602 during execution thereof by the computer system 600. As such, the main memory 604 and the processing device 602 also constitute computer-readable media. The instructions 622 may further be transmitted or received over a network via the network interface device 612.

While the computer-readable storage medium 620 is shown in the illustrative examples to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

The correlation of data, such as vehicle information, electronic device information, face information, and the like may be used beyond the identification of suspicious vehicles. As described below, such information may also be used to predict the location of an entity at a particular time. As used herein, an entity refers to any person(s), animal(s), vehicle(s), or any other suitable object that changes location in time. By predicting the location of an entity at a future time, one or more plans may be developed to allow the entity to avoid an undesirable or dangerous situation.

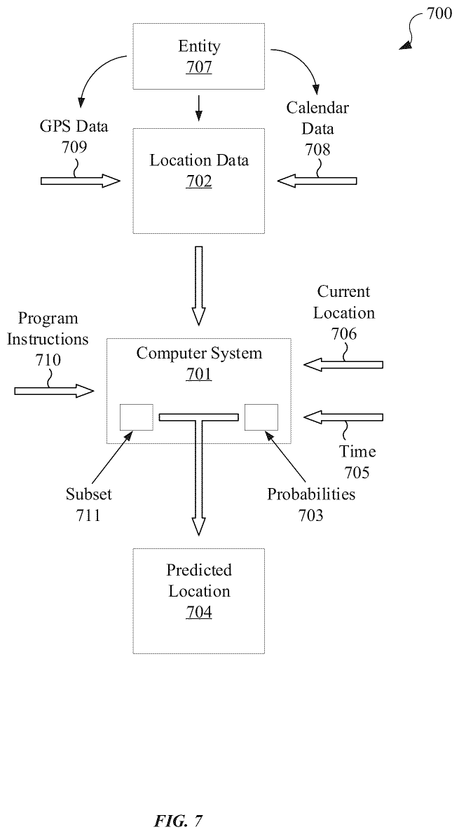

Turning to FIG. 7, a block diagram of a system for predicting a location of an entity is depicted. As illustrated, Computer system 701 is configured to execute program instructions 710 to perform various operations to determine predication location 704 of entity 707 at time 705. In various embodiments, computer system 701 may be implemented as a server that is configured to relay information to/from user equipment associated with entity 707. In other embodiments, computer system 701 may be implemented as user equipment associated with entity 707, such as a smartphone, or other suitable device.

Computer system 701 is configured to receive location data 702. In various embodiments, to determine location data 702, the location of entity 707 may be tracked over time using GPS data 709, which may be collected from a cellular telephone, a vehicle used by entity 707, detection of entity 707 at various locations using facial recognition, an integrated circuit or chip implanted into entity 707, and the like. Additionally, calendar data 708 from an electronic calendar associated with entity 707 may be used in the generation of location data 702.

Location data 702 may be expressed in terms of a set of location-time pairs (also referred to as “location-time values”) as shown in Equation 1. It is noted that the cardinality set [symbol] may be any suitable number. In some embodiments, the cardinality of set [symbol] may increase over time as more location-time pairs are added as part of on-going data gathering. In some embodiments, older location-time pairs may be removed from set [symbol] after a threshold time has elapsed or after a particular location has not been visited within a given period of time.

$$𝒮 = \{ ( {l}_{1} , {t}_{1} ) , ( {l}_{2} , {t}_{2} ) , ( {l}_{3} , {t}_{3} ) , ⋯ \} . \qquad ( 1 )$$

In various embodiments, locations l₁, l₂, and l₃ may be represented as a collection of at least two coordinates. In some cases, the at least two coordinates may include an x-coordinate and a y-coordinate specifying a particular location in a Cartesian location space. Alternatively, the at least two coordinates may include a radius and an angle specifying a particular location from an origin of a location space.

Since corresponding time values of many of the location-time pairs included in may not match time 705, computer system 701 is configured to identify, using a range of time values based on time 705, subset 711, which is a subset of set [symbol] .

To generate subset 711, computer system 701 is further configured to compare time values of different location-time pairs in set [symbol] according to Equation 2, where [symbol] ′ is subset 711, tₙ is time 705, and ε is a value that determines a size of the time range. In various embodiments, ε may be selected based on a desired resolution, in time, of the predicted location.

$${𝒮}^{′} = \{ ( {l}_{i} , {t}_{i} ) ∈ 𝒮 \vert {t}_{n} - ε < {t}_{i} < {t}_{n} + ε \} . \qquad ( 2 )$$

Computer system 701 is further configured to determine, using subset 711, respective probabilities 703, that entity 707 will be location in the respective locations specified in subset 711. In various embodiments, computer system 701 may be configured to determine individual ones of respective probabilities 703 using Equation 3, where P (lᵢ) is the probability that entity 707 will be at location lᵢ, | [symbol] ′| is the cardinality of subset 711, and |{(l, t)∈ [symbol] ′|l=lᵢ}| is the number of times lᵢ occurs in the location-time pairs included in subset 711.

$$P ( {l}_{i} ) = \frac{\vert \{ ( l , t ) ∈ {𝒮}^{′} \vert l = {l}_{i} \} \vert}{\vert {𝒮}^{′} \vert} \qquad ( 3 )$$

Computer system 701 is further configured, using respective probabilities 703, to determine predicted location 704 for entity 707 at time 705. To determine predicted location 704, computer system 701 is further configured to determine a particular location that corresponds to a maximum probability of respective probabilities 703. In various embodiments, computer system 701 may be configured to send predicted location 704 to user equipment, e.g., smartphone, associated with entity 707. Alternatively, or additionally, computer system 701 may be configured to send predicted location to one or more other entities which have been specified by entity 707. As described below, computer system 701 may be configured to predict a location for a different entity and determine a plan to for avoiding the different entity based on predicted location 704 and the location predicted for the different entity.

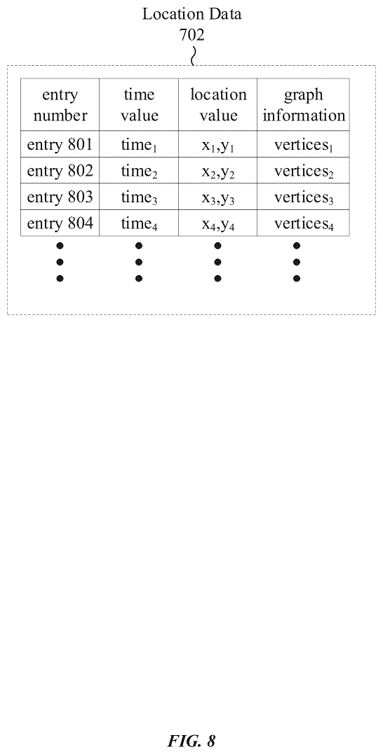

Turning to FIG. 8, a block diagram of an embodiment of location data 702 is depicted. As illustrated, location data 702 includes entries 801-804. It is noted that although only four entries are depicted in the embodiment of FIG. 8, in other embodiments, any suitable number of entries may be included in location data 702.

Entries 801-804 have corresponding time values, location values, and optional graph information. For example, entry 801 corresponds to time₁, location x₁, y₁, and vertices₁. In various embodiments, time₁ is indicative of when an entity was located at location x₁, y₁, and is a collection of one or more destination locations from location x₁, y₁.

The time values associated with entries 801-804 may be stored in any suitable format and granularity. For example, the time values associated with entries 801-804 may include information indicative of a date and a time value expressed in hours. In other embodiments, the time value may be expressed in hours, minutes, and seconds. Such time values may, in some embodiments, be expressed according to a reference time zone, e.g., Greenwich Mean Time (GMT), or as an offset from such a reference time zone.

As illustrated, the location values associated with entries 801-804 may employ any suitable units. For example, location x₁, y₁ may correspond to latitude and longitude values. Alternatively, location x₁, y₁ may correspond to a number of meters relative to an origin for a given location space. Although the corresponding location values for entries 801-804 are depicted as being xy coordinates, in other embodiments, different coordinate systems may be employed. For example, in some cases, a given location value may be expressed as a radial distance ρ from an origin, and an azimuth angle φ from a reference direction.

In some situations, locations of an entity may be restricted to a particular set of locations, and travel between locations in the set of locations may be limited to certain paths. In such cases, the location values associated with entries 801-804 may correspond vertices of a directed graph. The connectivity between such vertices is encoded in the graph information. For example, vertices₁ encodes information indicative of possible destination locations from location x₁, y₁. As described below, the graph information can be employed to determine a mostly likely path from a starting location to a most probable destination location.

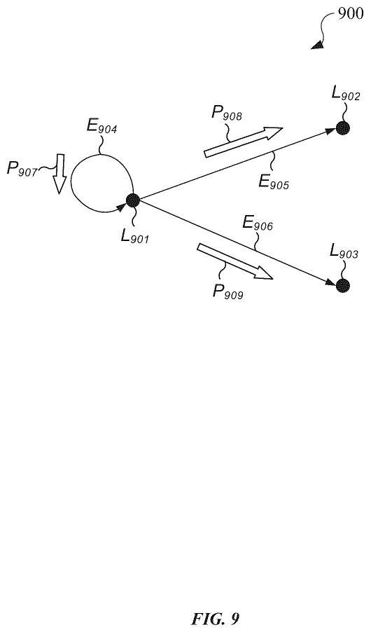

Turning to FIG. 9, a directed graph illustrating the prediction of a next location of an entity from a current location is depicted. As illustrated, directed graph 900 includes locations L₉₀₁, L₉₀₂, and L₉₀₃. Although only three locations (also referred to as “vertices”) are depicted in directed graph 900, in other embodiments, any suitable number of vertices and associated edges may be employed.

In the embodiment illustrated in FIG. 9, it is known that an entity is located at L₉₀₁. From L₉₀₁, the entity can remain at L₉₀₁ via edge E₉₀₄. Alternatively, the entity can move from L₉₀₁ to L₉₀₂ via edge E₉₀₅, or move to L₉₀₃ via edge E₉₀₆.

To predict to which of the allowed locations the entity will move, probabilities can be calculated for edges E₉₀₄, E₉₀₅, and E₉₀₆. For example, P₉₀₇ is the probability that the entity will remain at L₉₀₁, while P₉₀₈ is the probability the entity will move from L₉₀₁ to L₉₀₂. In various embodiments, the probability associated with traversing a particular edge, e.g., E₉₀₅, is based on a number of times the particular edge was traversed in a set of allowed destinations from the starting location.

Probabilities P₉₀₇, P₉₀₈, and P₉₀₉ can be calculated according to Equation 4, where [symbol] is a set of allowed locations from L₉₀₁, N is a number of elements of [symbol] , and δ is the Kronecker delta function.

$$P ( l ) = \frac{{\sum }_{i = 1}^{N} δ ( l , {s}_{i} )}{N} , where {s}_{i} ∈ 𝒮 \qquad ( 4 )$$

Once the individual probabilities have been calculated, a prediction of the next location for the entity can be made by selecting which next location has the largest associated probability as shown in Equation (5), where arg max is the “arguments of the maxima” function, which returns a particular value of l for which P(l) is maximum.

$${L}_{next} = arg {max}_{l} P ( l ) , for all l ∈ 𝒮 \qquad ( 5 )$$

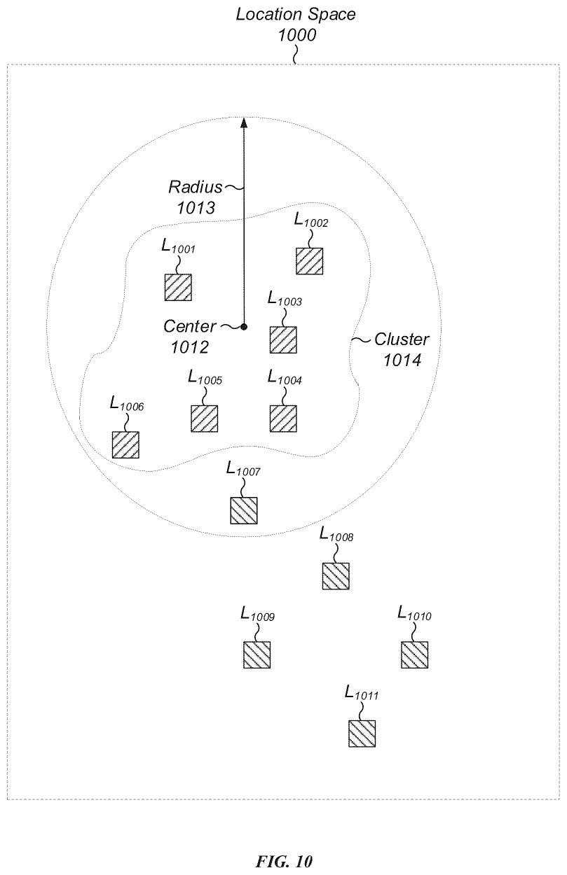

Turning to FIG. 10, a diagram for determining locations to avoid is depicted. As illustrated, location space 1000 includes locations L₁₀₀₁-L₁₀₁₁. In various embodiments, locations L₁₀₀₁-L₁₀₀₆ are possible locations for a first entity at a particular time. Locations L₁₀₀₁-L₁₀₀₆ may be determined using the embodiment of FIG. 7.

L₁₀₀₇-L₁₀₁₁ are locations that the first entity should avoid. In various embodiments, may correspond to possible locations of a second entity that the first entry is trying to avoid. In some embodiments, L₁₀₀₇-L₁₀₁₁ may be determined using the embodiment of FIG. 7 or any other suitable technique. In some cases, L₁₀₀₇-L₁₀₁₁ may include real-time location data for the second entity based on tracking the second entity's cellular telephone, vehicle, and the like.

In some embodiments, L₁₀₀₇-L₁₀₁₁ may correspond to high-traffic areas, road closures, or areas that local police, fire, or emergency services have requested people avoid due to an emergency situation. Alternatively, L₁₀₀₇-L₁₀₁₁ may correspond to locations that a homeland security agency has identified as dangerous due to bomb threats or other acts of terrorism.

Locations L₁₀₀₇-L₁₀₁₁ may, in some cases, be based on weather forecasts. For example, one of locations L₁₀₀₇-L₁₀₁₁ may correspond to a location that is prone to flooding and rain is forecast in the coming hours.

To determine which, if any, of locations L₁₀₀₇-L₁₀₁₁ should be avoided, a cluster analysis may be performed on results from Equation 3 to identify groupings of possible locations that are close to each other. In various embodiments, the cluster analysis may be performed using connectivity-based clustering, centroid-based clustering, distribution-based clustering, density-based clustering, or any other suitable cluster analysis technique.

For the identified clusters, a center of a cluster can be identified by calculating an average x-coordinate and an average y-coordinate using the coordinates of the predicted locations in the cluster. For example, the x-coordinate of center 1012 of cluster 1014 can be calculated using

Equation 6, where xᵢ is the x-coordinate of a given one of locations L₁₀₀₁-L₁₀₀₆, and Nis a number of locations in cluster 1014.

$${x}_{c} = {\sum }_{i = 1}^{N} \frac{{x}_{i}}{N} \qquad ( 6 )$$

In a similar fashion, the y-coordinate of center 1012 of cluster 1014 can be calculated using Equation 7, where yᵢ is the y-coordinate of a given one of locations L₁₀₀₁-L₁₀₀₆, and N is a number of locations in cluster 1014.

$${y}_{c} = {\sum }_{i = 1}^{N} \frac{{y}_{i}}{N} \qquad ( 7 )$$

Once the center of a cluster has been identified, a radius from the center can be determined that includes all of the locations within the cluster. For example, radius 1013 can be calculated using Equation 8, where [symbol] ₚ is a set of coordinate pairs for locations L₁₀₀₁-L₁₀₀₆, i.e., [symbol] ₚ={(x₁₀₀₁, y₁₀₀₁), (x₁₀₀₂, y₁₀₀₂), . . . }.

$${R}_{1013} = max \sqrt{{\vert {x}_{i} - {x}_{c} \vert}^{2} + {\vert {y}_{i} - {y}_{c} \vert}^{2}} , ∀ {x}_{i} , {y}_{i} ∈ {𝒮}_{p} \qquad ( 8 )$$

Using the center and radius associated with a cluster, individual ones of locations to be avoided can be checked to see if they fall within the circle defined by the determined center and radius. To perform the check, a distance from a given location to be avoided to the determined center of the circle is calculated. If the calculated distance is less than or equal to the determined radius, the predicted locations that determined the circle should be avoided.

The distance for a given one of locations L₁₀₀₇-L₁₀₁₁ can be calculated using Equation 9, where distᵢ is the distance from center 1012 to a given one of locations L₁₀₀₇-L₁₀₁₁, x_{c} is the x-coordinate of center 1012, and y_{c} is the y-coordinate of center 1012.

$$d i s {t}_{i} = \sqrt{{\vert {x}_{j} - {x}_{c} \vert}^{2} + {\vert {y}_{j} - {y}_{c} \vert}^{2}} \qquad ( 9 )$$

If any of the calculated distances are less that radius 1013, then the first entity should avoid L₁₀₀₁-L₁₀₀₆. For example, as illustrated in FIG. 10, the coordinates of L₁₀₀₇, i.e., x₁₀₀₇ and y₁₀₀₇ result in dist₁₀₀₇ being less than radius 1013, so locations L₁₀₀₁-L₁₀₀₆ should be avoided.

In some embodiments, when a determination is made that a set of predicted locations should be avoided, a message can be sent to the first entity. In some cases, the first entity can inquire for more specific information. A computer system, e.g., computer system 701, may, in response to such an inquiry, provide distances from various ones of L₁₀₀₁-L₁₀₀₆ to a closest one of locations L₁₀₀₇-L₁₀₁₁, allowing the first entity to selectively avoid the locations included in cluster 1014. Alternatively, the computer system may generate an avoidance plan which may include re-scheduling a scheduled event, selecting an alternative transportation method, and the like.

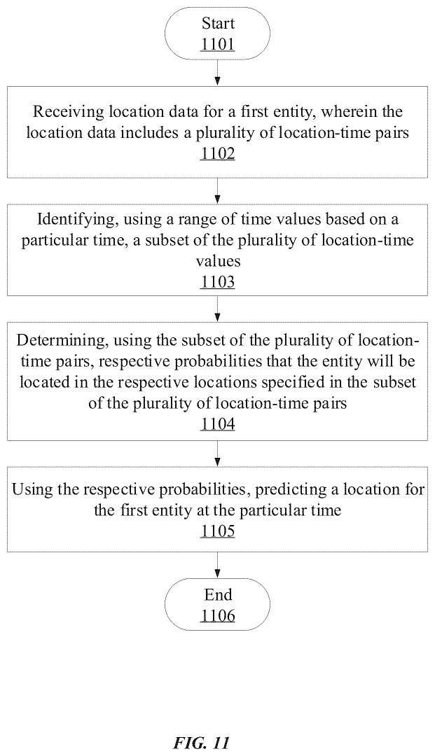

Turning to FIG. 11, a flow diagram depicting an embodiment of a method for predicting a location of an entity is illustrated. The method, which may be applied to various location systems, e.g., system 700 as depicted in FIG. 7, begins in block 1101.

The method includes receiving location data for a first entity (block 1102). In various embodiments, the location data includes a plurality of location-time pairs. In various embodiments, the current location data includes a particular location-time pair. In some cases, the method may include adding, using data received from a mobile communication device associated with the first entity, a new location-time pair to the plurality of location-time pairs. In other embodiments, at least one location-time pair of the plurality of location-time pairs corresponds to an electronic calendar entry associated with the first entity.

The method further includes identifying, using a range of time values based on a particular time, a subset of the plurality of location-time pairs (block 1103). In various embodiments, determining the subset of the plurality of location-time pairs includes determining an upper-time limit and a lower-time limit using the future time, and comparing respective time values of the plurality of location-time pairs to the upper-time limit and the lower-time limit.

The method also includes determining, using the subset of the plurality of location-time pairs, respective probabilities that the entity will be located in the respective locations specified in the subset of the plurality of location-time pairs (block 1104). In some embodiments, determining the respective probabilities includes determining a number of times a given location occurs within the subset of the plurality of location-time pairs, and generating, by dividing the number of times the given location occurs within the subset of the plurality of location-time pairs by a number of location-time pairs included in the subset, a particular probability of the respective probabilities.

The method further includes, using the respective probabilities, predicting a location for the first entity at the particular time (block 1105). In some cases, predicting the location for the first entity includes determining a largest probability in the respective probabilities.

In some cases, the method may also include, in response to determining a current location for the first entity is available, determining a second subset of the plurality of location-time pairs, where the plurality of location-time pairs correspond, at a current time, to a plurality of possible destinations from the current location. In various embodiments, the second subset of the plurality of location-time pairs includes a particular location-time pair corresponding to the current location and the current time. In such cases, the method may further include generating a plurality of probabilities that the first entity will be at corresponding destinations of the plurality of possible destinations at a next time subsequent to the current time.

In other cases, the method may also include determining a plan to avoid a second entity based on a predicted location of the second entity and a predicted location of the first entity. The method concludes in block 1106. It is noted that the embodiment of the method depicted in FIG. 11 may, in various embodiments, be implemented using a computer system, such as computer system 701.

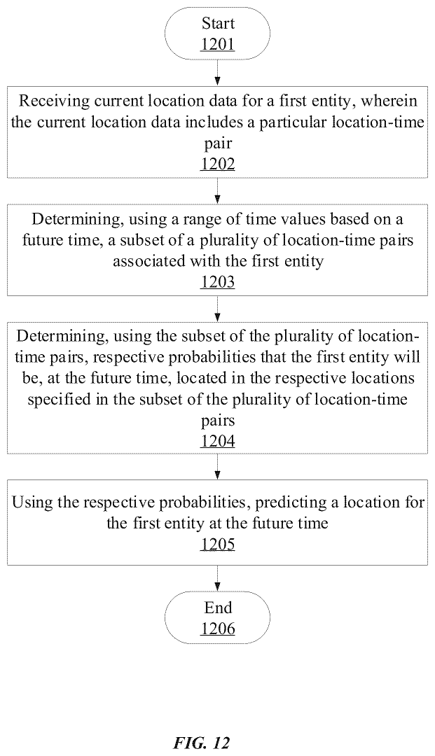

Turning to FIG. 12, a flow diagram depicting an embodiment of a method for predicting a next location for an entity from a current location of the entity is illustrated. In various embodiments, the method may be performed by one or more processors included in a server or a user device. The method, which may be applied to various location systems, e.g., location system 100 as depicted in FIG. 1A, begins in block 1201.

The method includes receiving current location data for a first entity (block 1202). In various embodiments, the current location data includes a particular location-time pair. In some cases, the particular location-time pair may be added to a previously received set of location-time pairs.

The method further includes determining, using a range of time values based on a future time, a subset of a plurality of location-time pairs associated with the first entity (block 1203). In various embodiments, determining the subset of the plurality of location-time pairs includes determining an upper-time bound and a lower-time bound using a threshold value. The method may further include comparing a time portion of a given location-time pair to the upper-time bound and the lower-time bound.

The method also includes determining, using the subset of the plurality of location-time pairs, respective probabilities that the first entity will be, at the future time, located in the respective locations specified in the subset of the plurality of location-time pairs (block 1204). In various embodiments, determining the respective probabilities includes determining a number of times a given location occurs in the subset of the plurality of location-time pairs, and dividing the number of time the given location occurs in the subset of the plurality of location-time pairs by a total number of location-time pairs included in the subset of the plurality of location-time pairs.

The method further includes, using the respective probabilities, predicting a location for the first entity at the future time (block 1205). The method concludes in block 1206. It is noted that the embodiment of the method depicted in FIG. 12 may, in various embodiments, be implemented using a computer system, such as computer system 701.

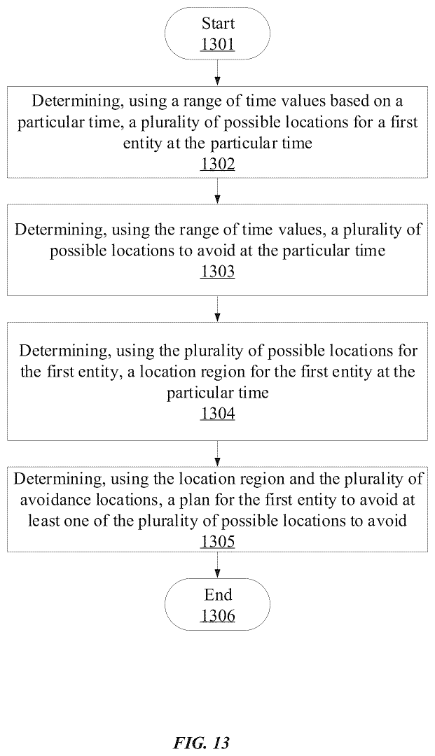

Turning to FIG. 13, a flow diagram depicting an embodiment of a method for determining locations to avoid is illustrated. The method which may be applied to various location systems, e.g., system 700 as depicted in FIG. 7, begins in block 1301.

The method includes determining, using a range of time values based on a particular time, a plurality of possible locations for a first entity at the particular time (block 1302). In various embodiments, determining the plurality of possible locations for the first entity can include performing the at least some of the steps of the methods depicted in the flow diagrams of FIG. 11 and FIG. 12.

The method further includes determining, using the range of time values, a plurality of possible locations to avoid at the particular time (block 1303). In some embodiments, determining the plurality of possible locations to avoid at the particular time can include performing at least some of the steps of the methods depicted in the flow diagrams of FIG. 11 and FIG. 12 using location-time pairs associated with an entity to be avoided. In some cases, such location-time pairs may include information indicative of areas identified by law enforcement, emergency services, and the like, as being problematic.

The method also includes determining, using the plurality of possible locations for the first entity, a location region for the first entity at the particular time (block 1304). In various embodiments, determining the location region for the first entity includes performing a cluster analysis on the plurality of possible locations for the first entity. The method may further includes determining a center and a radius for a circle using a subset of the plurality of possible locations for the first entity generated by the cluster analysis.

The method further includes determining, using the location region and the plurality of locations to avoid, a plan for the first entity to avoid at least one of the plurality of possible locations to avoid (block 1305). In some embodiments, determining the plan includes determining respective distances from the center to the plurality of possible locations to avoid and comparing the respective distances to the radius of the circle. The method may also include, in response to determining that a distance from a particular location of the plurality of possible locations to avoid is less than the radius of the circuit, determining the plan.

In various embodiments, the determined plan may include notifying the first entity to avoid all locations included in the location region. In other embodiments, the determined plan may include re-scheduled one or more events scheduled for the first entity. In some embodiments, the determined plan may include sending one or more inquiries to the first entity regarding future plans, and re-predicting the plurality of possible locations based on responses to the one or more inquiries.

The method concludes in block 1306. It is noted that the method depicted in FIG. 13 may, in various embodiments, be implemented using a computer system, such as computer system 701.

In other examples, route generation systems according to the principles of the present disclosure are configured, for the purpose of avoiding risk heightened events RHEs, to implement various techniques to generate navigation routes for users and/or vehicles. As used herein, an RHE may refer to one or more criminal activities/events and/or one or more other activities or events that a user may wish to avoid, such as dangerous road or weather conditions. In various examples, generating the routes may include generating particular routes to avoid specific entities, locations, and/or combinations thereof.

Route generation systems and methods described herein may be implemented using one or more devices and associated circuitry such as a computer system or computing device (e.g., the computer system 600 described in FIG. 6), one or more processors or processing devices configured to execute instructions stored in memory, and so on. Functions of the route generation systems and methods may be implemented by one or more of the devices individually or collectively. In other words, a single device may be configured to implement all of the functions, multiple devices may be configured to implement respective functions, or multiple devices may be configured to implement all of the functions.

Avoiding specific entities may include, but is not limited to, avoiding locations where the specific entities have been previously located, are currently located, and/or are predicted to be located (e.g., as predicted to be located at or near an indicated/desired time of travel). Locations of entities, either known or predicted, may be determined in accordance with any of the techniques for determining locations of entities as described above in FIGS. 1-13. Avoiding locations may include, but is not limited to, avoiding locations where RHEs (e.g., criminal events) have occurred and/or are predicted to occur. Determination of where criminal events have occurred (i.e., in the past) may be performed in accordance with crime-mapping data, such as crime mapping data stored in one or more databases and accessible/retrievable by the systems and methods of the present disclosure.

Conversely, prediction of where criminal events may occur (e.g., prediction of encountering criminal activity at a particular location, while traveling along a particular route, etc.) may be performed in accordance with: the crime-mapping data; previous, current, and predicted locations of entities; desired times of travel; and combinations thereof. Calculating or generating predictions of encountering criminal activity or other RHEs may include, but is not limited to, calculating one or more respective probabilities of encountering RHEs while traveling, at the desired time of travel, each respective route out of a plurality of possible routes.

As used herein, “locations” may refer to: street addresses; GPS or other navigation coordinates; a particular street and/or length or stretch of a street; a cross-section of two more streets; a block or other region bounded by one or more streets; regions or areas within a predetermined radius or distance of a street address, landmark or other specification of a determinable locations, navigation coordinates, an intersection, etc.; and/or any combination thereof.

As used in the embodiments described below, “vehicle” may refer to any vehicle or other mode of transportation driven by, occupied or ridden by (i.e., as a passenger), or intended to be driven or occupied by one or more individuals. “Vehicle” may include self-driven, autonomous, and semi-autonomous vehicles, private or public transportation, freight vehicles, municipal vehicles, recreational vehicles, boats, airplanes, etc. As used herein, “vehicle” may further refer to modes of transportation such as bicycles, motorcycles, and/or any other device used by an individual to facilitate transportation. Conversely, “user” may refer to a pedestrian or a driver or occupant of any type of vehicle as defined herein (including, without limitation, a car, taxi, bike, scooter, personal transport vehicle such as Segway, train, boat, airplane, hovercraft, jet pack service, public transportation, ride-hailing or ride-sharing service, etc.), including individuals using and/or intending to use a combination of pedestrian and vehicular travel for a given route.

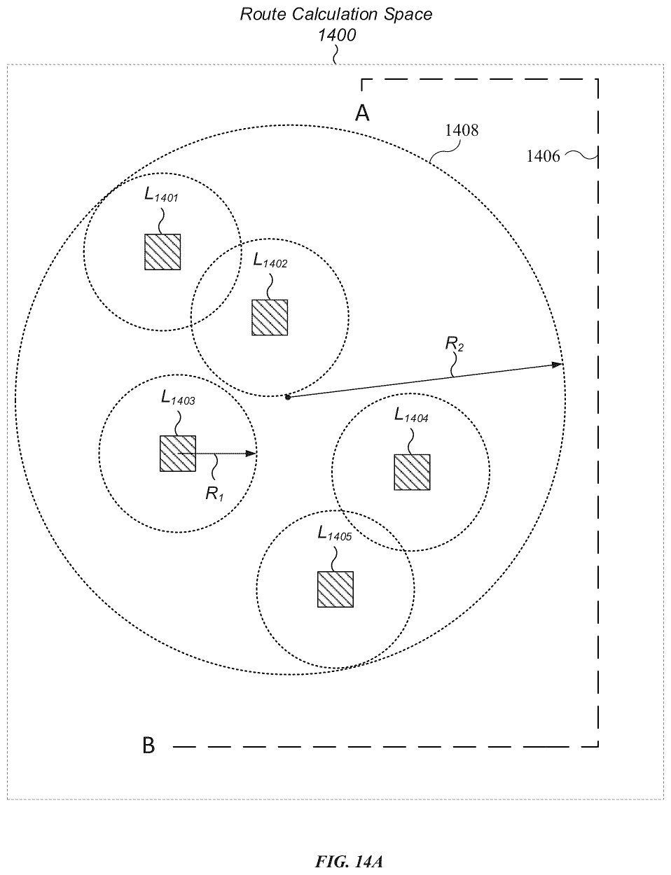

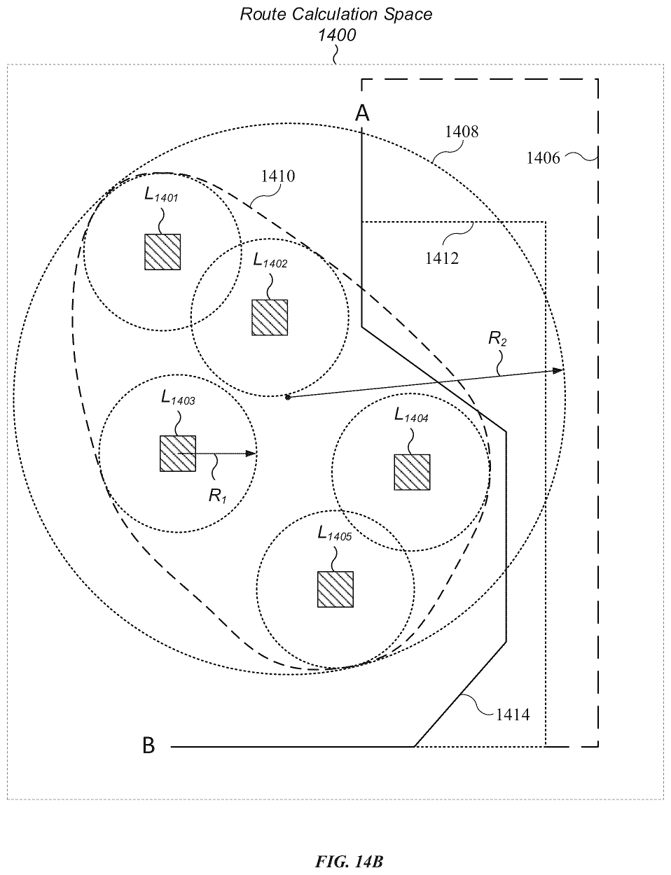

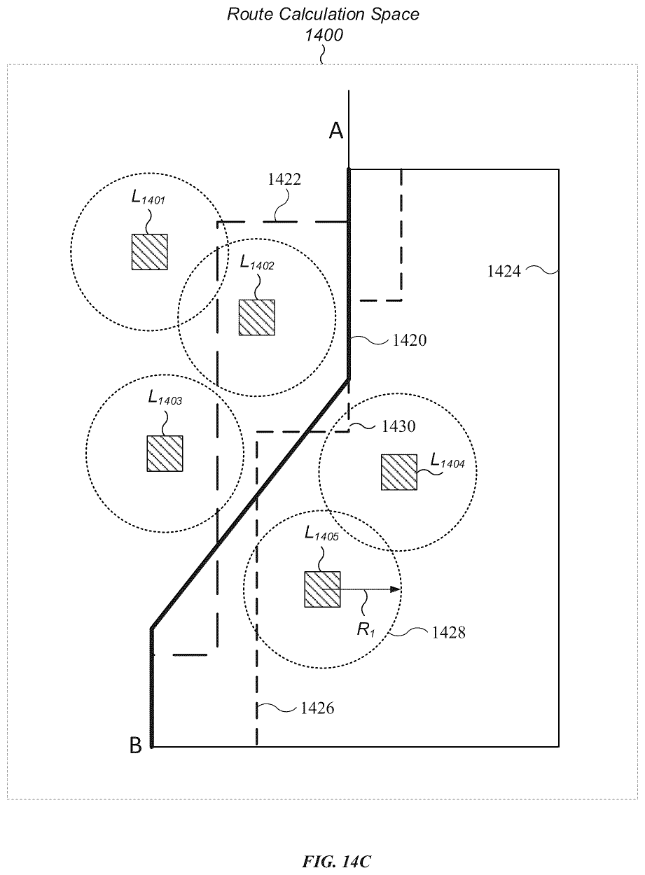

Referring now to FIG. 14A, a diagram illustrating a route calculation or generation space 1400 including locations to avoid L₁₄₀₁-L₁₄₀₅ is shown. In various embodiments, the locations L₁₄₀₁-L₁₄₀₅ may correspond to possible or approximate locations of an entity, a group of entities, etc. associated with RHEs as defined herein, including, but not limited to, criminal activity. In some embodiments, L₁₄₀₁-L₁₄₀₅ may be determined using the embodiments of FIG. 7 or any other suitable technique. In some cases, L₁₄₀₁-L₁₄₀₅ may include real-time location data for the second entity based on tracking the second entity's cellular telephone, vehicle, and the like in accordance with any embodiment described herein.

In some embodiments, L₁₄₀₁-L₁₄₀₅ may correspond to high-traffic areas, road closures, or areas that local, state, Federal, military or other police, fire, or emergency services have requested people avoid due to an emergency situation. Alternatively, L₁₄₀₁-L₁₄₀₅ may correspond to locations that a homeland security agency has identified as dangerous due to bomb threats or other acts of terrorism.

Locations L₁₄₀₁-L₁₄₀₅ may, in some cases, be based on weather forecasts. For example, one of locations L₁₄₀₁-L₁₄₀₅ may correspond to a location that is prone to flooding and where rain is forecast in the coming hours.

Each of the locations L₁₄₀₁-L₁₄₀₅ may be defined in accordance with a radius R1 from the respective location. The radius R1 may be the same (as shown) or different for each of the locations. For example, the radius R1 may be selected based on a type of the RHE associated with the corresponding location. In one example, the radius R1 may be greater for RHEs corresponding to criminal activity than for RHEs not corresponding to criminal activity.

In some embodiments, a cluster analysis may be performed as described above with respect to the embodiments of FIG. 10. In these embodiments, route generation may be performed based on avoidance of an entire cluster of locations or a cluster of a subset of locations in the route calculation space 1400. For example, a center of a cluster including the locations L₁₄₀₁-L₁₄₀₅ may be calculated (e.g., using Equations 6 and 7) and a radius R2 from the center that includes all of the locations within the cluster is determined (e.g., using Equation 8). In this manner, the route can be generated based on the radius R2 from the center (e.g., by calculating a route that does not pass within a region defined by the radius R2 from the center of the cluster). For example, a route 1406 from a first location A (e.g., a current or future location of a user, vehicle, etc., corresponding to an origination location) to a second location B (e.g., a destination location of the user or vehicle) may be calculated to avoid a region 1408 defined in accordance with the radius R2 from the center of the cluster of the locations L₁₄₀₁-L₁₄₀₅.

In other embodiments, route generation systems and methods according to the present disclosure are configured to perform boundary analysis (e.g., by implementing one or more boundary determination algorithms). For example, as shown in FIG. 14A, the route 1406 may be the only route within the route calculation space 1400 that does not pass through the region 1408. However, due to the relatively large region 1408 (i.e., relative to the actual locations L₁₄₀₁-L₁₄₀₅ and the radiuses R1), the route 1406 may be unnecessarily lengthy.

Accordingly, as shown in FIG. 14B, route generation systems and methods may be configured to perform boundary analysis to calculate a fitted boundary 1410. In some examples, as shown, the fitted boundary 1410 is calculated based on a minimum distance (e.g., the radius R1) from each of the locations L₁₄₀₁-L₁₄₀₅. In other examples, the fitted boundary 1410 is calculated based on the actual locations L₁₄₀₁-L₁₄₀₅ and routes may be calculated based on a minimum distance from the fitted boundary 1410. In other words, the fitted boundary 1410 is calculated to (i) enclose a region that contains all of the locations L₁₄₀₁-L₁₄₀₅ but (ii) minimize area (i.e., to minimize the inclusion of regions that do not include the locations L₁₄₀₁-L₁₄₀₅). In this manner, routes can be calculated that avoid the locations L₁₄₀₁-L₁₄₀₅ but do not add unnecessary length to travel time/distance.

To calculate the fitted boundary 1410, the various boundary calculation algorithms may be used, including, but not limited to, a convex hull algorithm, Delaunay triangulation, a flood fill algorithm, a region growing algorithm, and so on.

As one example, a route 1412 between the locations A and B may be calculated. While the route 1412 passes through the region 1408, the route 1412 avoids the region within the fitted boundary 1410. Accordingly, the route 1412 does not pass within the radius R1 of any of the locations L₁₄₀₁-L₁₄₀₅. However, a travel distance for the route 1412 is significantly less than a travel distance than the route 1406.

In other embodiments, route generations systems and methods according to the present disclosure may calculate a route (e.g., a route 1414) that passes through at least a portion of the region 1408, the fitted boundary 1410, etc. but does not pass within the radius R1 of any of the locations L₁₄₀₁-L₁₄₀₅. In other words, in embodiments where only routes that do not pass within fitted boundary 1410 are considered, the route 1414 would be excluded. However, in some examples, routes such as the route 1414 that pass within the fitted boundary 1410 may be provided in response to a determination that the route 1414 does not pass within the radius R1 of any of the locations L₁₄₀₁-L₁₄₀₅.

The embodiments described in FIGS. 14A and 14B correspond to generating routes that avoid passing through an entire region corresponding to an identified cluster of locations L₁₄₀₁-L₁₄₀₅ to be avoided by a user/driver. Conversely, FIG. 14C illustrates example route generation for one or more routes that pass between adjacent locations to be avoided. In this example, one or more routes may be generated based on respective probabilities of encountering one or more RHEs (e.g., criminal activity) along a particular route.

For example, an ideal path 1420 from location A to location B may be calculated. The ideal path 1420 may correspond to a shortest path between locations A and B that does not pass within the radius R1 of any of the locations L₁₄₀₁-L₁₄₀₅. However, the ideal path 1420 may not correspond to an actual available route. In other words, the ideal path 1420 may not correspond to actual roads or paths for a vehicle, or to biking or walking paths, etc. Accordingly, route generation systems and methods according to the present disclosure are configured to find one or more routes that (i) adhere as closely as possible to the ideal path 1420, (ii) correspond to actual roads/paths available to a vehicle or user (wherein such roads/paths may be selected or deselected based on additional optional criteria, such as the type, make or model of the vehicle and such as various demographic or ambulatory or medical characteristics of the user), and (iii) do not have an associated probability of encountering an RHE that exceeds a predetermined threshold probability.

A first calculated route 1422 may correspond to a shortest travel distance between the locations A and B. In other words, the first calculated route 1422 may correspond to an available route having a closest adherence (i.e. from a plurality of available routes) to the ideal path 1420. As one example, adherence to the ideal path 1420 may be calculated based on an area or integral between a given route and the ideal path 1420. As another non-limiting example, adherence to the ideal path 1420 may be calculated based on a difference between respective travel distances or times of the ideal path 1420 and a given route.

However, although the first calculated route 1422 may correspond to a shortest (e.g., shortest distance and/or time, depending on selectable criteria) possible route between the locations A and B, the first calculated route 1422 passes through three of the locations L₁₄₀₁-L₁₄₀₅ and therefore may have a probability of encountering an RHE that exceeds the predetermined threshold probability.

Conversely, a second calculated route 1424 may correspond to a shortest route that does not pass through any of the locations L₁₄₀₁-L₁₄₀₅. While the second calculated route 1424 does not pass through any of the locations L₁₄₀₁-L₁₄₀₅ (and therefore may have a probability of encountering an RHE that is below the predetermined threshold probability), the second calculated route 1424 may be unnecessarily lengthy relative to the ideal path 1420.

Accordingly, a third calculated route 1426 according to the present disclosure may correspond to a shortest possible route between the locations A and B that may not entirely avoid all of the locations L₁₄₀₁-L₁₄₀₅ (i.e., that passes within the radius R1 of at least one of the locations L₁₄₀₁-L₁₄₀₅) but nonetheless has an associated probability of encountering an RHE that is below the predetermined threshold probability as described below in more detail.

As used herein, various probabilities may be calculated as a probability value or values, a confidence interval, a non-probabilistic value, a numerical value, etc. As one example, the probability values may correspond to Bayesian probabilities, Markovian probabilities, a stochastic prediction, a deterministic prediction, and/or combinations thereof.

Each of the locations L₁₄₀₁-L₁₄₀₅ may be assigned a same or different respective probability (e.g., a baseline probability). The baseline probability may be fixed for a given one of the locations (e.g., <1%, 2%, 5%, etc.) or may be variable based on criteria including, but not limited to, a time of day, a type of RHE (e.g., a type of criminal activity associated with the location), a time elapsed since a known RHE occurred at the location, a frequency of RHEs occurring at the location, etc. As one example, each type of RHE may be assigned a different probability that decreases over time as time since the last RHE increases. For example, the baseline probability for a given location may be 5% for a first week after an RHE occurred, 4% for a second week after the RHE occurred, etc. The baseline probability may be reset (i.e., to 5%) or otherwise increased (e.g., by a predetermined increment, based on the type of RHE) in response to another RHE occurring at the same location. A rate at which the baseline probability decreases may be the same or different for different locations, types of RHEs, etc.

As one example, a first location corresponding to a route being traveled in the early afternoon by an automobile may be associated with: one or more RHEs that are less relevant to travel by vehicle (e.g., property crimes, such as larceny or vandalism); no recent RHEs (e.g. no RHEs within a previous week, month, etc.); and a low frequency of RHEs (e.g., one per week, month, etc.). Accordingly, the first location may be assigned a lowest baseline probability (e.g., <1%). Conversely, a second location corresponding to the same route being traveled in the late evening may be associated with at least one RHE that is particularly relevant to travel by vehicle (e.g., a carjacking). Further, the second location may be associated with a large amount or increase of the RHEs in a recent period, such as two or more carjacking attempts in a previous week. Accordingly, the second location may be assigned a highest baseline probability (e.g., 5%).

In still other examples, in some circumstances, a third location may be assigned a maximum probability (e.g., 100%). For example, if the third location is associated with an ongoing RHE (e.g., a bomb threat), the third location may be assigned the maximum probability to ensure that any calculated route avoids the third location.

For a given calculated route, a dynamic probability may be calculated for each of the locations L₁₄₀₁-L₁₄₀₅ based on the baseline probabilities and the actual route. For example, the dynamic probability may be calculated based on the baseline probability and at least one of (i) a minimum distance between the route and a center of a region 1428 (e.g., as defined by the radius R1) containing the corresponding location and (ii) an estimated amount of time that the user/vehicle will be in the region 1428. As one example, the dynamic probability assigned to a given location may be equal to (or, in some examples, greater than) the baseline probability for a route that passes directly through a center of the region 1428. Conversely, the dynamic probability may be less than the baseline probability for a route that passes through only an outer portion of the region 1428. In some examples, the probably decreases as the distance of the route from the center of the region 1428 decreases. The probability may decrease linearly or non-linearly (e.g., exponentially) and may be the same or different for different types of RHEs.

In examples where the dynamic probably is calculated at least partly based on the estimated amount of time that the user/vehicle will be in the region 1428, the estimated amount of time may be a factor of the mode of travel. For example, for a user traveling by automobile on a stretch of road without stop signs or traffic signals and with low traffic, the estimated amount of time may be relatively low (e.g., 30 seconds). Accordingly, the dynamic probability may be adjusted downward relative to the baseline probability. Conversely, for a user traveling by bicycle, the estimated amount of time may be relatively high (e.g., 5 minutes). Accordingly, the dynamic probability may be adjusted upward relative to the baseline probability.

For the example shown in FIG. 14C, the route 1420 passes through only outermost portions of the regions corresponding to the locations L₁₄₀₄ and L₁₄₀₅. Accordingly, even if the baseline probabilities associated with the locations L₁₄₀₄ and L₁₄₀₅ are relatively high (e.g., 4%), the dynamic probabilities for the route 1420 corresponding to the locations L₁₄₀₄ and L₁₄₀₅ may be relatively low (e.g., <1%). In some examples, the dynamic probabilities may be further adjusted based on an estimated amount of time spent within the regions as described above. In still other examples, the dynamic probabilities may be adjusted based on a number of stops or slowdowns within the regions. For example, the route 1420 has a turn (as shown at 1430) within the region corresponding to the location L₁₄₀₄. The turn 1430 may correspond to a stop sign. Accordingly, the turn 1430 may correspond to an upward adjustment to the dynamic probability.

In this example, the dynamic probabilities calculated for the route 1420 may be relatively low (e.g., as compared to the route 1422). For example, the dynamic probabilities for the route 1420 may be less than 1% for each of the locations L₁₄₀₄ and L₁₄₀₅. Accordingly, an overall probability calculated for the route 1422 may be less than the predetermined threshold probability. For example, the overall probability may be calculated based on an average of the dynamic probabilities (i.e., the dynamic probabilities of each region that the route 1422 passes through), a weighted average, a union of probabilities, etc. Accordingly, for a user traveling from location A to location B, the route generation system of the present disclosure may generate and provide (e.g., at a user interface) the route 1422 as a suggested or recommended route.

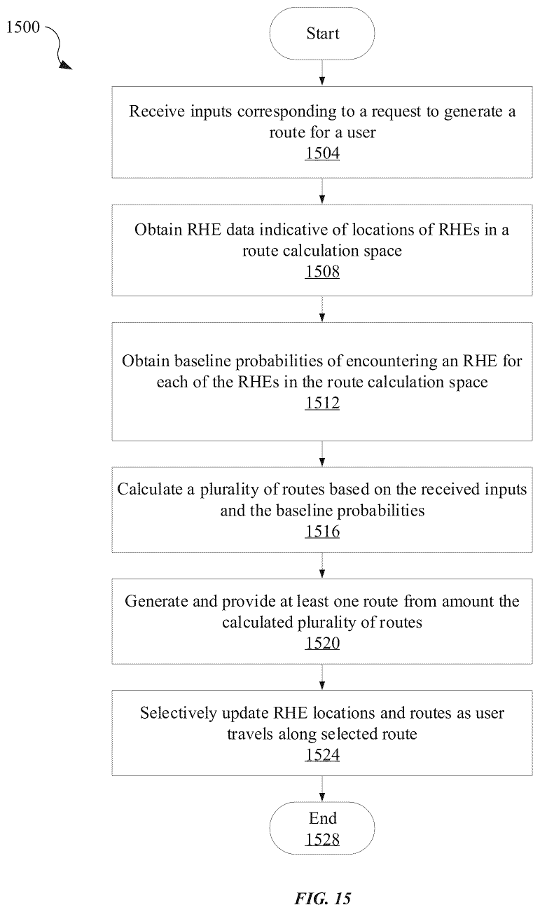

FIG. 15 is a flow diagram depicting a method 1500 for generating a route to avoid locations according to the present disclosure. The method 1500 may be implemented using one or more devices and associated circuitry such as a computer system or computing device (e.g., the computer system 600 described in FIG. 6), one or more processors or processing devices configured to execute instructions stored in memory, and so on. In some examples, the method 1500 is responsive to inputs from a user (e.g., from a user device, such as a smartphone, vehicle navigation device, or other computing device). One or more of the functions of the method 1500 may be implemented at the user device (e.g., receiving inputs, providing one or more generated routes, etc.) while other functions of the method 1500 may be performed at the user device, at another computing device (e.g., a remote computing device), and combinations thereof.

At block 1504, the method 1500 receives inputs corresponding to a request to generate a route for a user. The inputs identify various criteria for the requested route, including, but not limited to: a first (e.g., origination) location, a second (e.g., destination) location, a desired departure time or range of times from the first location, a mode of travel (e.g., vehicle, public transportation, walking, etc.), a desired predetermined threshold probability, a desired minimum distance from identified RHEs (e.g., the radius R1 as defined above), a maximum desired travel time, etc.

At block 1508, the method 1500 obtains RHE data indicative of locations of RHEs (“RHE locations”) in a route calculation space containing the first and second locations. For example, the RHE data may correspond to crime mapping data stored in one or more databases and accessible/retrievable by the method 1500 and/or RHE locations calculated/predicted using any of the techniques described herein. Obtaining the RHE data includes populating the route calculation space with one or more RHE locations based on the RHE data. At block 1512, the method 1500 obtains baseline probabilities of encountering an RHE for each of the RHE locations in the route calculation space. In some examples, the baseline probabilities are obtained from a lookup table or other stored indexing data that correlates types of RHEs with respective baseline probabilities. In other examples, the baseline probabilities are obtained using a formula or model (e.g., implemented by a computing device) configured to calculate a baseline probability based on inputs such as type of RHE, time of day, most recent RHE, frequency of RHEs, etc.

At block 1516, the method 1500 calculates a plurality of routes between the first location and the second location based on the received inputs and the baseline probabilities for each of the RHE locations in the route calculation space. In some examples, the calculated routes include, but are not limited to: an ideal path from the first location to the second location; a shortest route that corresponds to an actual available route; a route having a lowest probability of encountering an RHE; and one or more routes that do not have a lowest probability of encountering an RHE but have a shorter travel time and/or distance than the route having the lowest probability of encountering an RHE. Calculating the one or more routes may include calculating a dynamic probability for each of the RHE locations and calculating an overall probability of encountering an RHE for each of the calculated routes. In some examples, the dynamic probabilities are obtained from a lookup table or other stored indexing data that correlates adjustments (e.g., upward or downward) of baseline probabilities with inputs such as distance from a center of a region including an RHE location, estimated amount of time spent in a region including an RHE location, etc. In other examples, the dynamic probabilities are calculated using a formula or model (e.g., implemented by a computing device) configured to calculate a dynamic probability based on inputs such as distance from a center of a region including an RHE location, estimated amount of time spent in a region including an RHE location, etc.

At block 1520, the method 1500 generates and provides (e.g., outputs for display on an interface of a device), based on the received inputs and the calculated overall probabilities, at least one route from among the calculated routes. As one example, the at least one route is a shortest route between the first location and the second location that has an overall probability less than the predetermined threshold probability. In some examples, the method 1500 outputs a plurality of routes including the shortest route, the route having the lowest overall probability, and the shortest route having overall probability less than the predetermined threshold probability. Outputting the routes may including outputting, for display: data indicating the overall probability of each of the routes; data indicating RHE locations along each route; data indicating types of RHEs associated with each of the RHE locations; etc. In this manner, the user may select from among the plurality of routes.

At block 1524, upon selection of a route, the method 1500 selectively updates the RHE locations and routes as the user travels from the first location to the second location along the selected route (e.g., until the user arrives at the second location). For example, updating the routes may include adding or removing RHE locations in view of updated RHE information (e.g., in one or more databases, in response to real-time reports of RHEs, etc.), updating baseline and/or dynamic probabilities, recalculating routes based on the updated RHE information and probabilities and a current location of the user, etc.

At block 1528, the method 1500 ends. For example, the method 1500 ends upon arrival of the user at the second location.

In some examples, route generation systems and methods as described herein may be implemented by a ride-hailing service. For example, the route generation systems and methods may be implemented by a computing device associated with the ride-hailing or ride-sharing service, collectively by respective computing devices associated with the ride-hailing or ride-sharing service and a user of the ride-hailing or ride-sharing service, etc. As one example, a computing device of a user requesting transportation from a ride hailing or ride-sharing service implements the route generation system described above to generate the route and provide, from the computing device of the user to the computing device associated with a ride-hailing or ride-sharing service, information that indicates the generated route. For example, a preferred route generated in accordance with the techniques described herein is provided to the ride-hailing or ride-sharing service along with the request for transportation. In this manner, a user may require that the ride-hailing or ride-sharing service follow the generated route provided by the user. In some examples, a transaction between the ride-hailing or ride-sharing service and the user may be contingent upon the ride-hailing or ride-sharing service agreeing to the generated routed provided by the user. For example, a driver associated with the ride-hailing or ride-sharing service may be prompted to accept or reject the generated route provided by the user.

In addition to providing notifications as described above, the present disclosure may provide notification of suspicious people in public spaces. For example, the present disclosure may enable the provision of notifications to relevant users and/or authorities, including law enforcement and private security, of criminals in subways. In addition, given the high correlation of people who jump turnstiles in public transportation networks and people with outstanding warrants, the present disclosure may detect people jumping turnstiles and notify law enforcement and/or private security. As a further example, the preset disclosure may provide notifications of intrusion in restricted areas of a hospital.

Consistent with the above disclosure, the examples of systems and method enumerated in the following clauses are specifically contemplated and are intended as a non-limiting set of examples.

Clause 1. A method for generating one or more routes for the purpose of avoiding locations of risk-heightened events (RHEs), the method comprising:
receiving first data indicating a first location, wherein the first location corresponds to an origination location of at least one of a user and a vehicle occupied by the user;
receiving second data indicating a second location, wherein the second location corresponds to a destination location of the at least one of the user and the vehicle occupied by the user;
receiving third data indicating one or more criteria related to traveling between the first location and the second location, the third data indicating at least one of: (i) a mode of travel between the first location and the second location and (ii) a desired departure time for traveling between the first location and the second;
obtaining fourth data indicating the locations of RHEs in a route calculation space containing the first location and the second location;
calculating, based on the first data, the second data, the third data, and the fourth data, at least one route between the first location and the second location; and
generating and providing, at an interface of a first device associated with the user, route information that indicates the at least one route.

Clause 2. The method of any clause herein, wherein the RHEs correspond to criminal activity.

Clause 3. The method of any clause herein, wherein calculating the at least one route comprises:
retrieving, from one or more databases, the fourth data, wherein the fourth data corresponds to RHEs occurring (i) within the route calculation space and (ii) within one or more predetermined timeframes relative to the desired departure time;
calculating, based on (i) the RHEs, (ii) the one or more predetermined timeframes, and (iii) the desired departure time, one or more respective probabilities of encountering RHEs while traveling each of a plurality of possible routes within the one or more predetermined timeframes; and
selecting, from among the plurality of possible routes based on the respective probabilities and the one or more criteria, the at least one route between the first location and the second location.

Clause 4. The method of any clause herein, wherein calculating the one or more probabilities includes calculating, for each of the locations of the RHEs, a baseline probability of encountering an RHE.

Clause 5. The method of any clause herein, wherein calculating the one or more probabilities includes calculating, based on (i) the baseline probabilities for each of the locations of the RHEs and (ii) the plurality of possible routes, a dynamic probability for each of the locations of the RHEs.

Clause 6. The method of any clause herein, wherein calculating the one or more probabilities includes calculating, for each of the plurality of possible routes, an overall probability of encountering an RHE that is based on one or more of the dynamic probabilities along a respective one of the plurality of possible routes.

Clause 7. The method of any clause herein, wherein selecting the at least one route includes selecting, based on the overall probabilities, a shortest route from among the plurality of possible routes that has an overall probability less than a predetermined threshold probability.

Clause 8. The method of any clause herein, wherein the one or more criteria include the predetermined threshold probability.

Clause 9. The method of any clause herein, wherein providing the at least one route includes providing, at the interface of the first device, (i) a shortest route from among the plurality of routes, (ii) the shortest route from among the plurality of possible routes that has the overall probability less than the predetermined threshold probability, and (iii) a route that has a lowest overall probability among the plurality of possible routes.

Clause 10. The method of any clause herein, further comprising receiving, from the first device associated with the user, the first data, the second data, and the third data.

Clause 11. The method of any clause herein, further comprising providing, from the first device associated with the user to a second device associated with a ride-hailing service, the route information.

Clause 12. The method of any clause herein, further comprising, at the second device, prompting a driver associated with the ride-hailing service to accept or reject the at least one route.

Clause 13. The method of any clause herein, wherein the one or more criteria include a maximum allowable variation of time between (i) a fastest possible route between the first location and the second location and (ii) the at least one route.

Clause 14. The method of any clause herein, wherein the one or more criteria include a maximum allowable variation in distance traveled between (i) a shortest possible route between the first location and the second location and (ii) the at least one route.

Clause 15. The method of any clause herein, wherein the one or more criteria include a maximum allowable overall duration of travel for the at least one route.

Clause 16. The method of any clause herein, wherein the one or more criteria include a maximum allowable duration of time spent within respective regions corresponding to the locations of RHEs.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle.

What is claimed is:

1. A method for generating one or more routes for the purpose of avoiding locations of risk-heightened events (RHEs), the method comprising:
receiving first data indicating a first location, wherein the first location corresponds to an origination location of at least one of a user and a vehicle occupied by the user;
receiving second data indicating a second location, wherein the second location corresponds to a destination location of the at least one of the user and the vehicle occupied by the user;
receiving third data indicating one or more criteria related to traveling between the first location and the second location, the third data indicating at least one of: (i) a mode of travel between the first location and the second location and (ii) a desired departure time for traveling between the first location and the second;
obtaining fourth data indicating the locations of RHEs in a route calculation space containing the first location and the second location;
calculating, based on the first data, the second data, the third data, and the fourth data, at least one route between the first location and the second location; and
generating and providing, at an interface of a first device associated with the user, route information that indicates the at least one route.

2. The method of claim 1, wherein the RHEs correspond to criminal activity.

3. The method of claim 1, wherein calculating the at least one route comprises:
retrieving, from one or more databases, the fourth data, wherein the fourth data corresponds to RHEs occurring (i) within the route calculation space and (ii) within one or more predetermined timeframes relative to the desired departure time;
calculating, based on (i) the RHEs, (ii) the one or more predetermined timeframes, and (iii) the desired departure time, one or more respective probabilities of encountering RHEs while traveling each of a plurality of possible routes within the one or more predetermined timeframes; and
selecting, from among the plurality of possible routes based on the respective probabilities and the one or more criteria, the at least one route between the first location and the second location.

4. The method of claim 3, wherein calculating the one or more probabilities includes calculating, for each of the locations of the RHEs, a baseline probability of encountering an RHE.

5. The method of claim 4, wherein calculating the one or more probabilities includes calculating, based on (i) the baseline probabilities for each of the locations of the RHEs and (ii) the plurality of possible routes, a dynamic probability for each of the locations of the RHEs.

6. The method of claim 5, wherein calculating the one or more probabilities includes calculating, for each of the plurality of possible routes, an overall probability of encountering an RHE that is based on one or more of the dynamic probabilities along a respective one of the plurality of possible routes.

7. The method of claim 6, wherein selecting the at least one route includes selecting, based on the overall probabilities, a shortest route from among the plurality of possible routes that has an overall probability less than a predetermined threshold probability.

8. The method of claim 7, wherein the one or more criteria include the predetermined threshold probability.

9. The method of claim 7, wherein providing the at least one route includes providing, at the interface of the first device, (i) a shortest route from among the plurality of routes, (ii) the shortest route from among the plurality of possible routes that has the overall probability less than the predetermined threshold probability, and (iii) a route that has a lowest overall probability among the plurality of possible routes.

10. The method of claim 1, further comprising receiving, from the first device associated with the user, the first data, the second data, and the third data.

11. The method of claim 10, further comprising providing, from the first device associated with the user to a second device associated with a ride-hailing service, the route information.

12. The method of claim 11, further comprising, at the second device, prompting a driver associated with the ride-hailing service to accept or reject the at least one route.

13. The method of claim 1, wherein the one or more criteria include a maximum allowable variation of time between (i) a fastest possible route between the first location and the second location and (ii) the at least one route.

14. The method of claim 1, wherein the one or more criteria include a maximum allowable variation in distance traveled between (i) a shortest possible route between the first location and the second location and (ii) the at least one route.

15. The method of claim 1, wherein the one or more criteria include a maximum allowable overall duration of travel for the at least one route.

16. The method of claim 1, wherein the one or more criteria include a maximum allowable duration of time spent within respective regions corresponding to the locations of RHEs.
